(19) United States
(12) Patent Application Publication
(10) Pub. No.: US 2003/0009403 A1
(43) Pub. Date: Jan. 9, 2003

(54) Method and system for providing enhanced forms of financial instruments

(76) Inventor: Neil C. Sapp, Miami, FL (US)

Correspondence Address: KILPATRICK STOCKTON LLP, 607 14TH STREET, N.W., SUITE 900, WASHINGTON, DC, 20005, US

(21) Appl. No.: 10/170,640

(22) Filed: Jun. 14, 2002

Related U.S. Application Data
(60) Provisional application No. 60/298,715, filed on Jun. 15, 2001.

(51) Int. Cl. G06F 17/60

(52) U.S. Cl. 705/35

(57) ABSTRACT

The present invention relates particularly to a method and system for providing enhanced forms of traditional financial instruments with added perquisites in addition to the normal financial benefits normally associated with the traditional financial instruments. The enhancements or added perquisites include, for example, the right of the instrument owner to purchase offered products/services at advantageous rates, a line of credit to purchase the offered products/services at advantageous rates, and the spinning off of such rights for separate resells.

### PRIORITY

This application claims the benefit of U.S. Provisional Patent Application No. 60/298,715, titled “CONSUMER PARTICIPATING FINANCIAL INSTRUMENT™ (CPFI™) The CPFI Air Travel Mile™ (ATM™) is used as an example,” filed Jun. 15, 2001, which is herein incorporated by reference in its entirety.

### BACKGROUND OF THE INVENTION

1. Field of the Invention

The present invention relates to the field of financial instruments. More particularly, the present invention relates to a system and method for providing enhanced forms of traditional financial/investment instruments that facilitate advantageous benefits in terms of products and services offered by entities issuing the instruments to purchasers/owners of the instruments.

2. Background

As understood in the art, financial instruments are those instruments having monetary values or recording monetary transactions. They are also called investment instruments because they are often used as investment tools by investors. Traditional financial instruments such as stocks, bonds, debentures, certificate of deposits (CDs), capital notes, and vouchers provide investment opportunities in different ways. For stocks, an investor can achieve financial gains by buying low and selling high and/or receiving dividends paid out to certain types of stocks. For bonds, debentures, CDs, capital notes, and vouchers, an investor can achieve financial gains by also buying low and selling high and/or reaping in the interest associated with owning such interest-bearing instruments. The problem with a traditional financial instrument is that other than relying on its past market performance for investment decisions, an investor has no other incentives to invest in that particular instrument. Hence, entities wishing to raise capitals by issuing financial instruments constantly face stiff competition from one another for potential investors and need other means to entice the investors to purchase their particular financial instruments. Additionally, business entities always need more capital, customers, and profit-making products and/or services, and the financial services industry is constantly looking for new products other than the traditional financial instruments to sell, trade, and broker.

### SUMMARY OF THE INVENTION

Thus, there exists a need for a method and system for providing new financial products to satisfy the financial services industry while at the same time enticing prospective investors to purchase such products and engage entities issuing such products.

Accordingly, the preferred embodiments of the present invention provide a method and system for constructing, issuing, and managing enhanced forms of traditional financial/investment instruments that facilitate added benefits in terms of products and services offered by the instrument-issuing entity to entice investment in such instruments, raise capital for the issuing entity, entice new customers, and/or enhance or build loyalty among existing or new customers.

The preferred embodiments of the present invention also provide enhanced forms of traditional financial instruments, such as stocks, bonds, debentures, CDs, capital notes, and vouchers; wherein enhancements are achieved by adding/attaching special perquisites to these otherwise ordinary financial/investment instruments to create new products for the financial services industry, investors, and consumers.

The preferred embodiments of the present invention also provide a method and system for providing enhanced financial instruments (FIs), termed Consumer Participating Financial Instruments™ (CPFIs™) that can be issued by any entity, private or public, corporate, government or otherwise, in lieu of or in addition to the traditional financial instruments for effectively raising capital.

Additional aspects and novel features of the invention will be set forth in part in the description that follows, and in part will become more apparent to those skilled in the art upon examination of the present disclosure.

### BRIEF DESCRIPTION OF THE DRAWINGS

The preferred embodiments of the present invention are illustrated by way of example and not limited to the following figures and appendices, in which:

FIG. 1 depicts a computerized system for constructing and managing enhanced financial instruments in accordance with an embodiment of the present invention;

FIG. 2 depicts a more detailed representation of the CPFI™ system in FIG. 1, in accordance with an embodiment of the present invention;

FIG. 3 depicts the mechanisms that facilitate both the construction of a CPFI™ and the flow of capital, goods, and services in the transaction and utilization of the enhanced financial instrument;

FIG. 4 depicts the computerized system of FIG. 1 specifically for constructing and managing air travel financial instruments in accordance with an embodiment of the present invention;

FIG. 5 depicts a more detailed representation of the ATMFI™ system shown in FIG. 4 in accordance with an embodiment of the present invention;

FIG. 6 depicts the mechanisms as shown in FIG. 3 but specifically for the transaction and utilization of air travel financial instruments (FIs), in accordance with an embodiment of the present invention;

FIGS. 7-12 depict the subsystem shown in FIG. 5 for the selection of various basic instrument types during the construction of an air travel FI in accordance with an embodiment of the present invention;

FIGS. 13-20 depict the subsystem shown in FIG. 5 for the selection of various special instrument perquisites during the construction of an air travel FI in accordance with an embodiment of the present invention;

FIGS. 21-24 depict the various subsystems of the management system shown in FIG. 5 in accordance with an embodiment of the present invention;

FIGS. 25-33 depict various examples of air travel FIs in accordance with various embodiments of the present invention; and

FIGS. 34 and 35 depict a more general presentation of FIG. 6 for the transaction and utilization of air travel FIs with values found in the examples shown in FIGS. 25-33.

### DETAILED DESCRIPTION OF THE INVENTION

Reference is now made in detail to the preferred embodiments of the present invention, illustrative examples of which are illustrated in the accompanying drawings, showing a method and system for providing enhanced forms of traditional financial instruments, such as stocks, bonds, debentures, CDs, capital notes, and vouchers. These enhancements are achieved by adding/attaching one or more special perquisites to otherwise ordinary financial/investment instruments.

According to the preferred embodiments of the present invention, one of the special perquisites is the right of the financial instrument owner, upon purchasing the instrument from the issuing entity, to purchase products and/or services offered by the issuing entity at an advantageous predetermined rate and/or discount. The offered products and/or services may be provided by the issuing entity itself or by other entities affiliated with the issuing entity. The predetermined rate can be predicated on a cost-plus, cost-minus, or price-minus scheme. In a cost-plus scheme, the consumer is able to purchase the product/service at a predetermined amount above the cost to produce such product/service. In a cost-minus scheme, the consumer is able to purchase the product/service at a predetermined amount below the cost to produce such product/service. In a price-minus scheme, the consumer is able to purchase the product at a predetermined amount below the advertised/shown, and/or negotiated, price of the product/service. The types of offered products and/or services, as well as the schemes for the predetermined rate and/or discount, may be determined by the issuing entity, based on factors such as business strategies involving the marketing of the financial instruments, products, and/or services. There is an old adage in business: “find a problem and solve it” or, “find a need and fill it.” Hence, an issuing entity can, for instance, identify the needs of consumers for a particular product or service and provide such needed product/service as a perquisite to an enhanced financial instrument it wishes to issue in an effort to raise the desired capital, entice new customers, or enhance or build loyalty among existing or new customers.

A second special perquisite that can be attached to the enhanced financial instrument of the present invention is the right of the instrument owner to purchase the offered products/services on credit, at the option of the entity issuing the instrument. This credit option can be based on the monetary size of the underlying instrument and its use of collateral. A third special perquisite is the right of the instrument owner to sell off the special instrument benefits as subscription perquisites, much like subscription warrants, again at the option of the entity issuing the instrument. The difference between the subscription perquisites of the present invention and the conventional subscription warrants is that the subscription perquisites pertain to services and/or tangible products as opposed to intangible products such as securities. Other special perquisites may deal with advance purchase, accumulation, transfer (e.g., resell, gift), assumption, and convertibility benefits of the instrument owner.

Employees of a business usually receives the products/services offered by the business at costs lower than that of a regular customer. The owner of the business often receives a similar or better benefit to the products/services offered by the business. Hence, with the enhanced financial instruments (FIs) of the present invention, a buyer of each instrument can become an investor/owner/lender/financial partner in the issuing entity in order to gain advantageous benefits to products/services offered by the issuing entity in addition to those benefits normally associated with the traditional types of instruments. According to the present invention, the enhanced FI is termed a consumer participating financial instrument™ (CPFI™) for the add-on benefits that it confers on the participating consumers/investors upon the purchase of such instrument. As with traditional financial instruments, enhanced FIs of the present invention can be in various forms, such as bonds, debentures, stocks (common or preferred), capital notes, vouchers, etc. The type of enhanced FI to be issued is again based on the desire of the issuing entity. The construction and implementation of such enhanced financial instruments can be achieved by a computerized system, including the use of data networks, private or public, and other communication networks such as voice telephony. This system is described next.

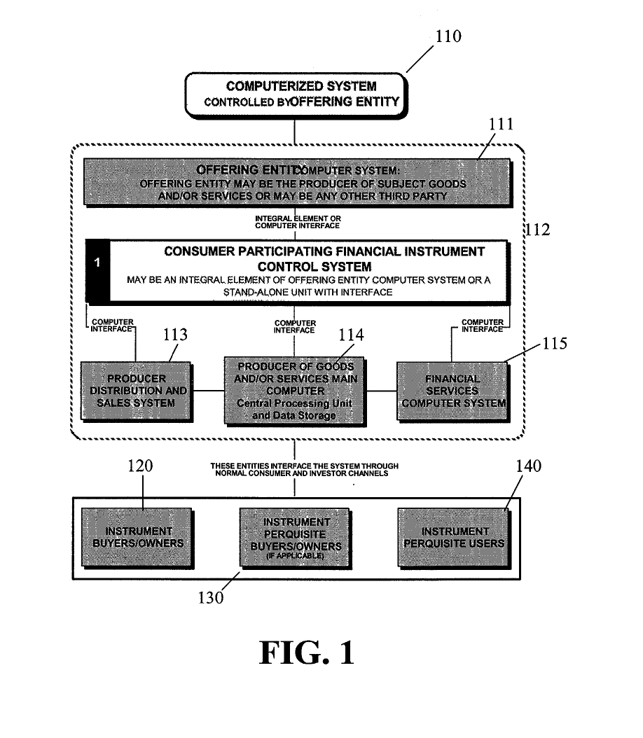

FIG. 1 depicts a computerized system 110 controlled by the offering entity (i.e., issuing entity) for constructing and managing the enhanced FIs to accommodate the flow of capital and services in an enhanced FI transaction and utilization, in accordance with one embodiment of the present invention. The computerized system includes an offering entity computer system 111. As mentioned earlier, the offering/issuing entity may be the actual provider or producer of the subject goods and/or services or a third party other than the actual producer. The offering entity computer system 111 is interfaced with the CPFI control system 112. In the event that the offering entity is the actual producer of the subject goods and/or services, the CPFI control system 112 may be an integral element of the offering entity computer system 111. Alternatively, it can be a stand-alone system decoupled from but interfaced with the offering entity computer system 111. The CPFI control system 1112 and the offering entity computer system 111 interface with the producer distribution and sales system 113 and the producer main computer system 114 to facilitate the construction and management (i.e., transaction and utilization) of enhanced FIs for the offering entity computer system 111. Both the CPFI control system 112 and the offering entity computer system 111 also interface with the financial services system 115 to issue, via normal consumer and investor channels, the constructed enhanced FIs and manage their distribution to enhanced FI buyers/owners 120, buyers/owners of the perquisites in the enhanced FIs 130 (i.e., those who have bought off the subscription perquisites from the actual enhanced FI buyers/owners), and users of such perquisites (who can be the actual enhanced FI buyers/owners or those granted with such perquisites by the buyers/owners) 140.

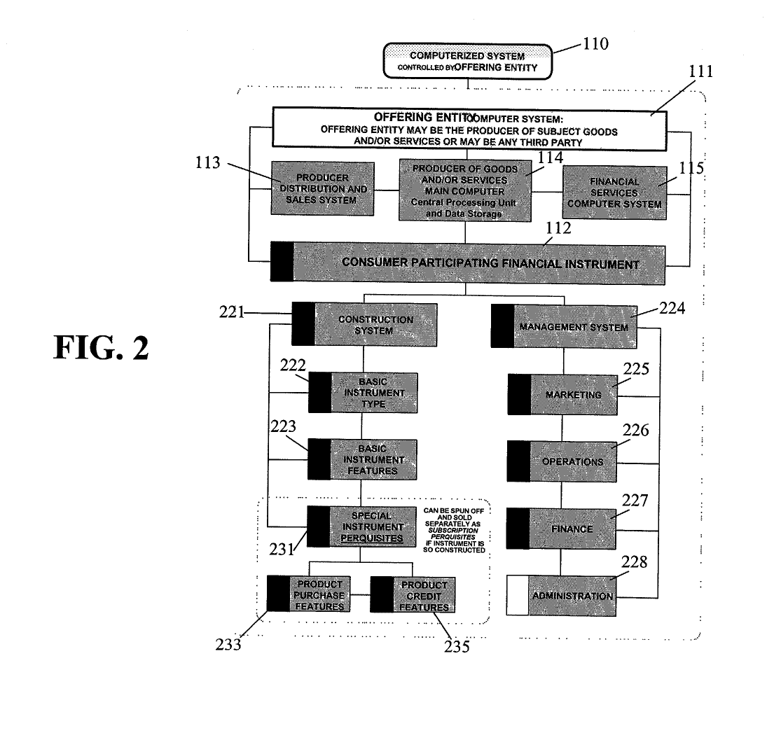

FIG. 2 shows a further breakdown of the CPFI control system 112, with like elements retaining the same labeling as shown in FIG. 1. The CPFI control system 112 includes a construction system 221 and a management system 224. The construction system 221 includes a subsystem 222 for constructing basic instrument type 222, a subsystem 223 for constructing basic instrument features 223, and a subsystem 231 for constructing special instrument perquisites. The subsystem 231 includes a subsystem 233 for constructing product purchase features and a subsystem 235 for constructing product credit features. The subsystem 231 and its subsystems 233 and 235 can be spun off and sold separately as subscription perquisites if the instrument is so constructed with such perquisites, as mentioned earlier. The management system 224 includes a subsystem 225 for marketing of the enhanced FIs, a subsystem 226 for handling the operations of the overall CPFI control system 112, a subsystem 227 for handling the finance relating to the construction and management of the enhanced FIs, and a subsystem 228 for handling the administration associated with the construction and management of the enhanced FIs.

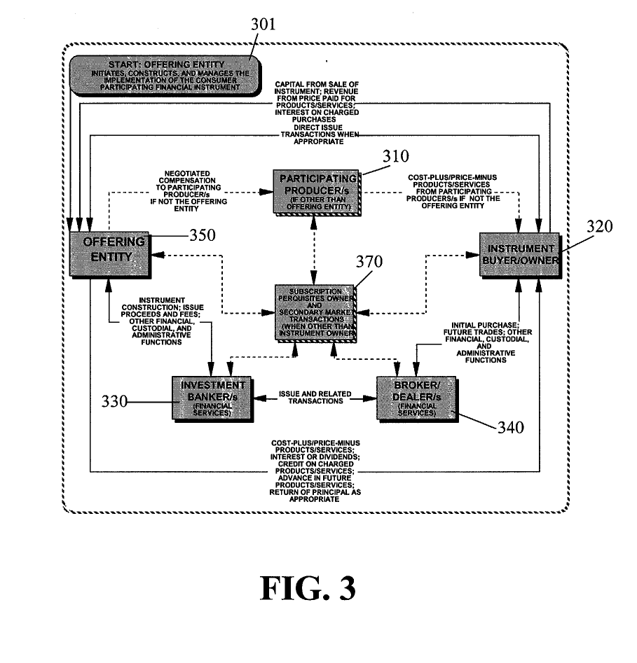

FIG. 3 depicts the mechanisms that facilitate both the construction of the enhanced FI and the flow of capital, goods, and services in the transaction and utilization of the enhanced FI by the offering entity computer system 111 and CPFI control system 112 shown in FIGS. 1 and 2. At start 301, systems 111 and 112 interact with one another to initiate, construct, and manage the implementation of the enhanced FI at the offering entity 350. Again, if the offering entity 350 is not the actual producer of the subject goods and/or services, it will then enter into negotiations with participating producer(s) 310 in order to construct enhanced FIs with add-on products and/or services from the producer(s) 310 as perquisites. The enhanced FI is then issued and offered to an instrument buyer/owner 320 via the investment banker 330 and broker/dealer 340 and the normal consumer and investor channels. As part of the purchase of the enhanced FI, the buyer/owner 320 will receive as perquisites one or more of the following benefits: 1) the add-on products and/or services provided by the participating producer(s) 310; 3) the interest and/or dividend for the enhanced FI; 3) a line of credit on the charged add-on products and/or services; 4) an advance in future products and/or services; and 5) a return of principal, as applicable. In return, the offering entity 350 will receive one or more of the followings: 1) capital from the sale of the instrument; 2) revenue from price paid for used add-on products and/or services; and 3) an interest on charged purchases of add-on products and/or services. The offering entity then provides negotiated compensation to the participating producer(s) 310 for products and/or services rendered to the buyer/owner 320 (that is, if the offering entity is not the actual producer). FIG. 3 also depicts a secondary market 370 where the offering entity 350, investment banker 330, broker/dealer 340, and buyer/owner 320 can resell the enhanced FIs or subscription perquisites spun off from enhanced FIs, as mentioned earlier.

An example of an enhanced FI specifically designed to offer air travel as a perquisite to consumers/investors is now described in accordance with an embodiment of the present invention. According to this embodiment, the air travel enhanced financial instrument, or air travel FI, is termed Air Travel Mile™ CPFI™ (ATMFI™). It can be constructed and issued as a cost-plus based instrument. Alternatively, as mentioned earlier, it can also be constructed and issued as a cost-minus or price-minus based instrument without deviating from the concept of the present invention. The air travel FI provides a solution to a number of problems encountered by the airline industry. For instance, the general traveling public feels that airline ticket pricing is confusing, illogical, and frequently unfair. The business traveler feels even more negatively because he/she often feels exploited and frequently punished for making last-minute or non-restricted flight reservations due to business needs. As air-travel consumers, both the general traveling public and the business traveler often do not know, from one day to the next, what it might cost to fly to a desired destination. This is because airline seats are highly perishable products and, on average, approximately 35% go unused. Furthermore, the airlines' incessant effort to minimize this problem and improve their yield, through a highly complex system of yield management, contributes significantly to the wide variance in ticket pricing. Because of this, no one on any given flight seems to have paid the same price as anyone else for exactly the same product. The air-travel consumers finds this to be confusing, illogical, and unfair. Compounding to this negative thinking, the typical air traveler does not relate the law of supply and demand to air travel. He/she subconsciously thinks of it like a taxi or bus ride and expects his cost to be based just as it is on these conveyances, i.e., on the distance traveled. Hence, the air-travel consumers believe it costs too much to fly, especially on a safer, major carrier without any restrictions. Hence, the air-travel consumers are frustrated, resentful, unable to budget accurately for their future air travel needs, and demand logic, predictability, value, and safety for air travel. Coincidentally, air-travel consumers are a part of the public at large that is also looking for attractive, sound investments. Likewise, the financial services industry always needs new products to sell, trade, and broker, and the airlines, like other business entities, always need more capital, customers, and profit-making fares.

The air travel FI provides a logical, predictable, reasonable, flexible, and profitable solution to address the needs of the air-travel consumers, airlines, and the financial services industry. It provides a special air travel benefit or perquisite that gives the air-travel consumer the right to purchase air travel from an airline at a fare based solely on the distance to be flown at a known rate per mile. The air-travel consumer can obtain this perquisite and also become an investor by purchasing (and thus investing in) an air travel FI of the airline. The airline can make known the rate per mile so that the air travel FI fares are lower than the standard fares for any given flight segments in order to attract prospective consumers/investors, yet high enough to make profits of the air travel FI fares. Because the known rate per mile makes the airfare easy to compute, the air-travel consumers can accurately predict costs and budget for future travel, and thus find air travel to be predictable, logical, and fair. Furthermore, with the investment in an air travel FI, the air-travel consumer is made an owner/lender/financial partner in the airline and reaps the benefits of air travel often entitled to only the owner and/or employees of the airline. Hence, the consumer's benefits include not only the monetary return on an attractive and sound investment but also the right to air travel at greatly reduced, known-rate fares which are based on the distance to be flown.

The air travel FI also provides a viable means for its owner to fly on major airlines at fares comparable to, or better than, those of smaller, low-cost airlines. One motivating factor causing the air-travel consumer to prefer the major airlines is the perception that they are safer and, in most cases, such perception is correct. Major airlines will therefore be motivated to maintain their safety standards because the air travel FI business will have such a positive financial impact on them. All other airlines will therefore be motivated to develop higher safety standards because they will desire to participate in the air travel FI business as well. Also, because the air travel FI consumer/investor pays less for airfares, he/she will likely travel more, and there will increasingly be more like-minded consumers wanting to purchase and own the same benefits.

As a result of the increased air travel by air travel FI consumers/investors at set profit making fares, airlines can capture an increased number of profit-paying customers and obtain higher load factors to complement existing revenue. New revenue can come from two types of leisure and/or personal travelers: those who are attracted by the more consistently affordable and rational fares but who would not travel much otherwise, and those who are attracted for the same reasons who already travel a modest amount and will now travel more. New revenue can also come from additional business travel for the same reasons. Much business travel, which is now avoided because of irrational prices and restrictions, can now be feasible with the air travel FI business model. With the increase in revenue, airline financial performance improves and becomes reasonably predictable, which spurs easier and better management and safety maintenance to ultimately provide a better and safer product to society. Airline financial performance also improves as a result of return on investment (ROI) from new capital generated by the sale of air travel FIs. Furthermore, the air travel FIs also provide badly needed new capital that many airlines could not raise otherwise to sustain or expand their businesses. In recap, the air travel FIs facilitate business growth by providing more available capital, less debt, stronger balance sheets, and more customers flying at profit-making fares.

To the financial services industry, the air travel FI (and the enhanced FI in general) provides a compelling, distinctive, fresh new product with powerful economic potential, a new infusion of capital to support and sustain the financial instrument markets, and a large new piece of the world airline multibillion-dollar revenue pie. The financial services industry can also provide the wherewithal and expertise for management of the new capital generated by the product. Together, the airlines, travel service companies, and financial services industry can provide a sophisticated and natural marketing infrastructure for the air travel FI product.

As with the general enhanced FI, the specific air travel FI can have various types or forms, such as air travel bond, air travel debenture, air travel common share (i.e., stock), and air travel preferred share. Each air travel FI type can further be broken down into a particular air travel class (e.g., coach, business, first, or multi-class) with different benefit variations for each air travel FI type and air-travel class. Thus, an infinite number of benefit variations is possible for the air travel FI product.

The examples of different types of air travel FI to be described next have been structured to depict and quantify the product for reader understanding only and, in some instances, to suggest the use of certain options which may provide increased marketability. However, it should be understood that decisions on the type/form, features, options, and numerical values for an air travel FI, as with the general enhanced FI, resides with the issuing entity based on its desires. The issuing entity must also decide for itself the number of instruments it will issue. The specific needs and financial goals of the issuing entity are examples of some of the factors determining which instruments and how many of them are issued. In some instances, all forms of the instrument may be issued by the same entity, regardless of specific needs and goals, simply to provide more choice for the consumer. The determination of which air travel FI will be purchased rests with each consumer/investor. Travel requirements (e.g., availability, cost, benefits) and investment requirements (e.g., growth, income, risks) are some of the factors determining the form of air travel FI that the consumer/investor will purchase.

As mentioned earlier, some of the various forms of the air travel FI include: bond, debenture, share-common, and share-preferred, capital note, CD, voucher, etc. The features and options for each chosen form of the air travel FI include, for example:

face amount?

par value? If yes, at what rate, when paid, and how paid?

dividend? If yes, what rate, when paid, how paid.?

Maturity date? If yes . . . when?

Callable? If yes . . . when?

Redeemable prior to maturity date? If yes . . . when and at what amount? (Redemption provisions)

Voting right?

Cumulative?

Air travel benefits?

Travel Class:

Coach Class

Business Class

First Class

Multi-Class Type I

Multi-Class Type II

Multi-Class Type III

Others (an infinite number of variations possible on these benefits)

Maximum distance (may be unlimited) which can be flown per designated time period?

Length of designated time period and when it starts?

Percent factor above airline cost factor to compute fare? (Assume a cost-plus based CPFI™ system)

Unit of measure for distance (statute mile, nautical mile, kilometer, etc.)?

Unit of measure for time (day, month, year, other?)

Cumulative?

Transferable?

Assumable?

Advanceable?

Charge privilege for air travel?

If yes, maximum amount, interest rate, repayment terms.

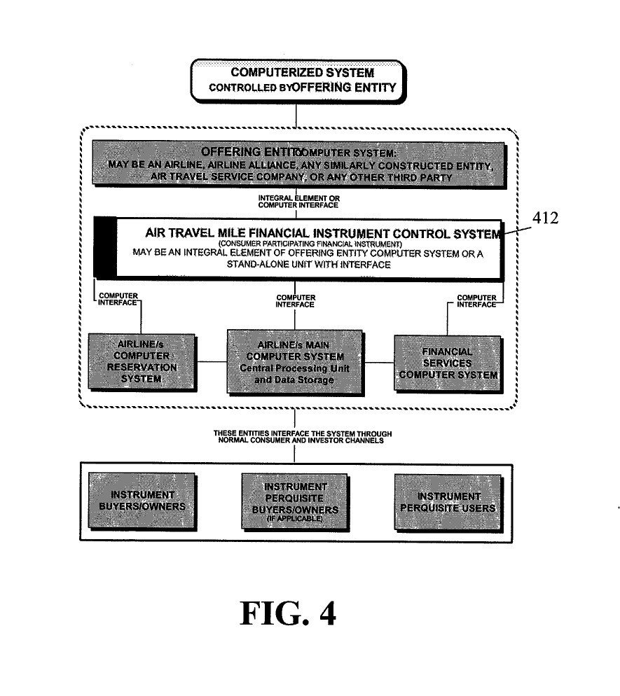

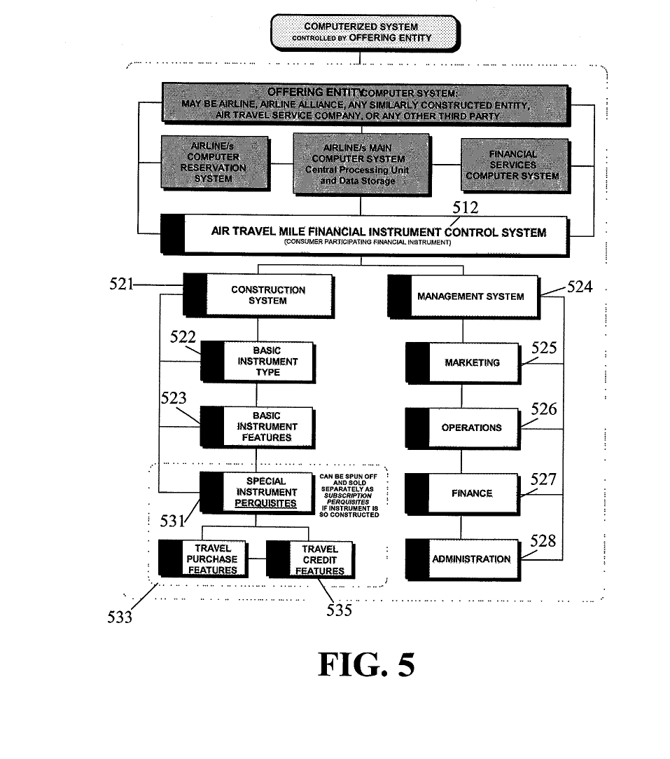

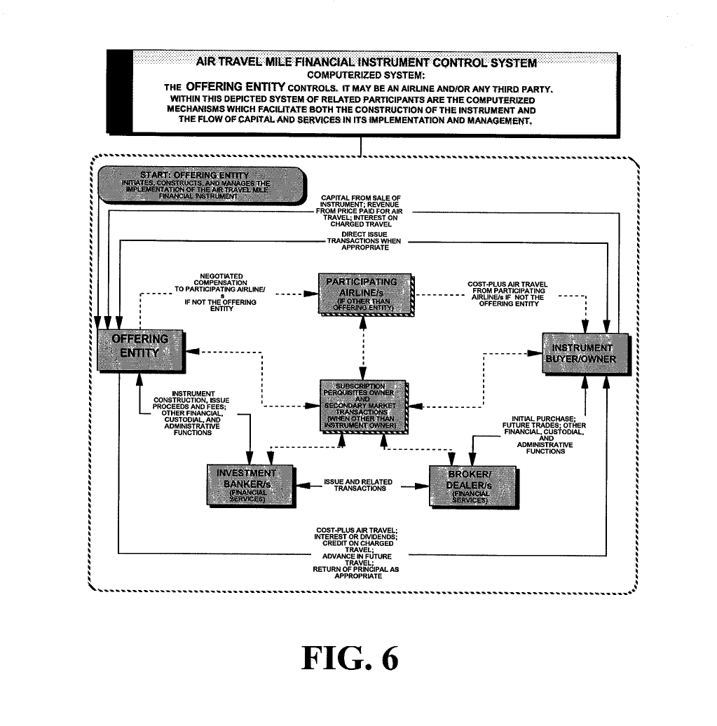

FIG. 4 depicts the computerized system of FIG. 1 that is specific for constructing, issuing, and managing the air travel FIs, in accordance with one embodiment of the present invention. Likewise, FIG. 5 is similar to FIG. 2 in that it depicts a further breakdown of the CPFI control system 412 shown in FIG. 4, and FIG. 6 depicts the mechanisms shown in FIG. 3 but specific for facilitating both the construction of the air travel FI and the flow of capital, goods, and services in the transaction and utilization of the air travel FI. As with FIG. 2, the subsystem 531 in FIG. 5 for constructing the travel and credit perquisites can be bundled and spun off from the basic instrument of the air travel FI for later sale as subscription perquisites if the instrument is so constructed by the offering entity. According to one embodiment of the present invention, the credit perquisites are designed to piggyback on the travel perquisites.

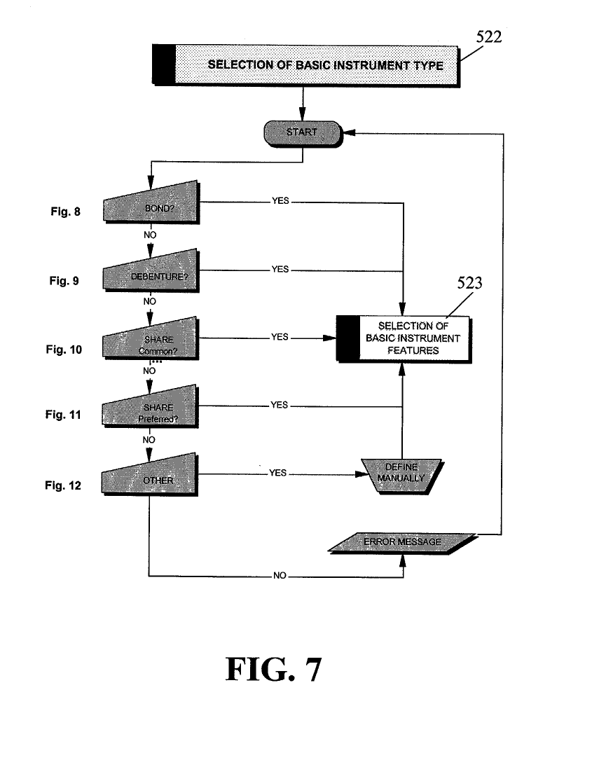

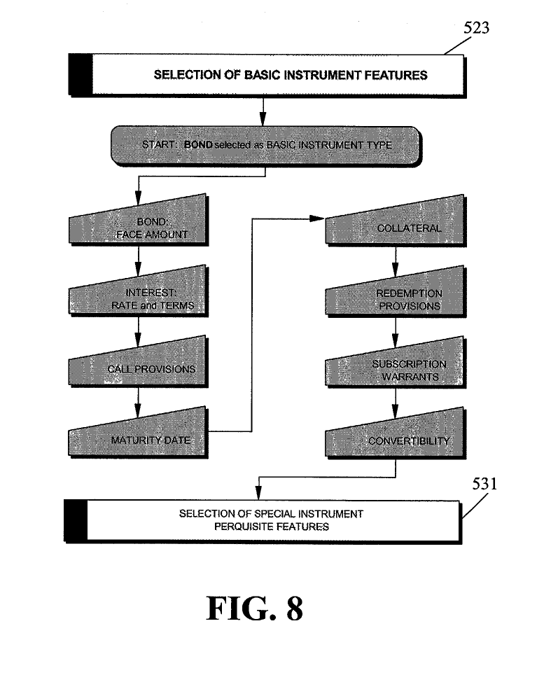

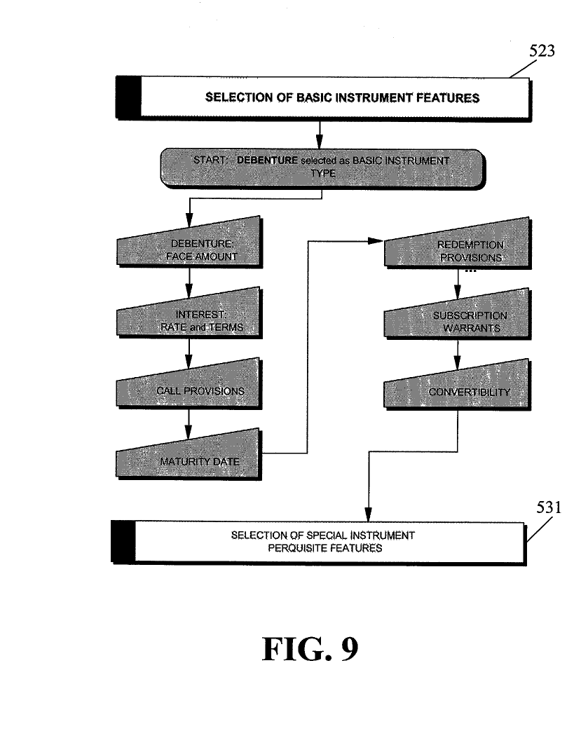

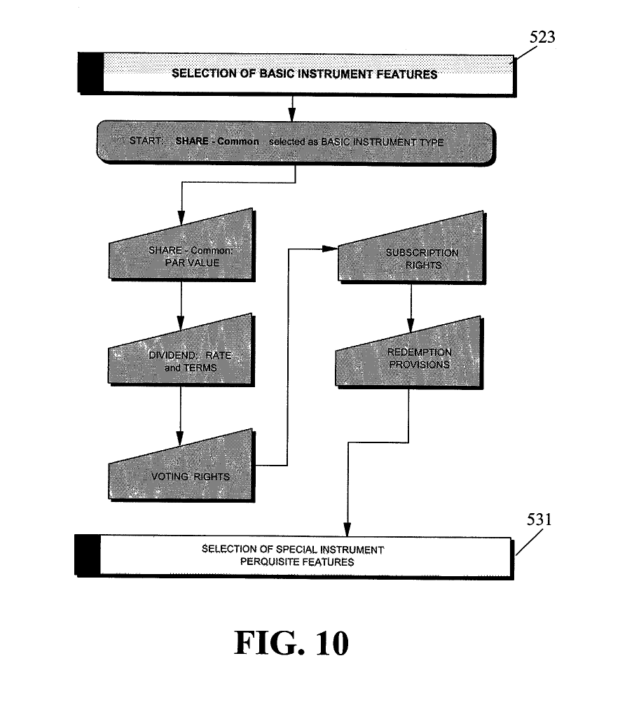

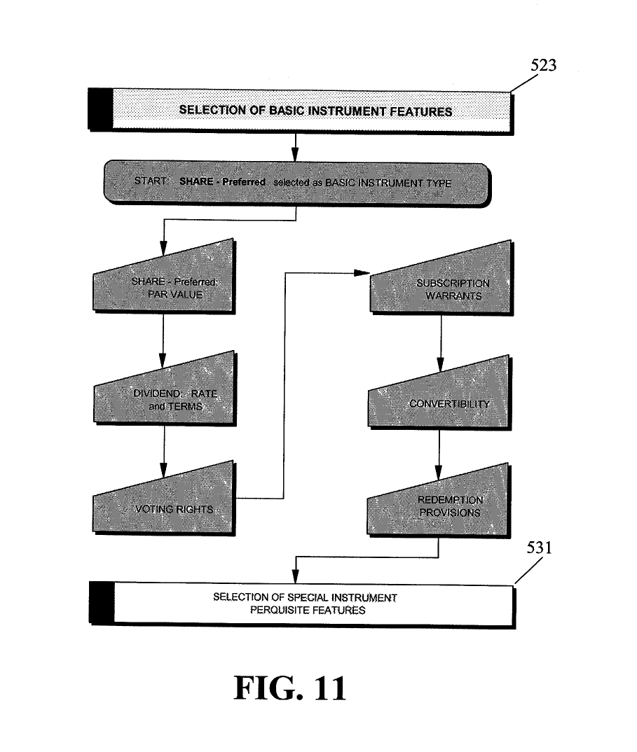

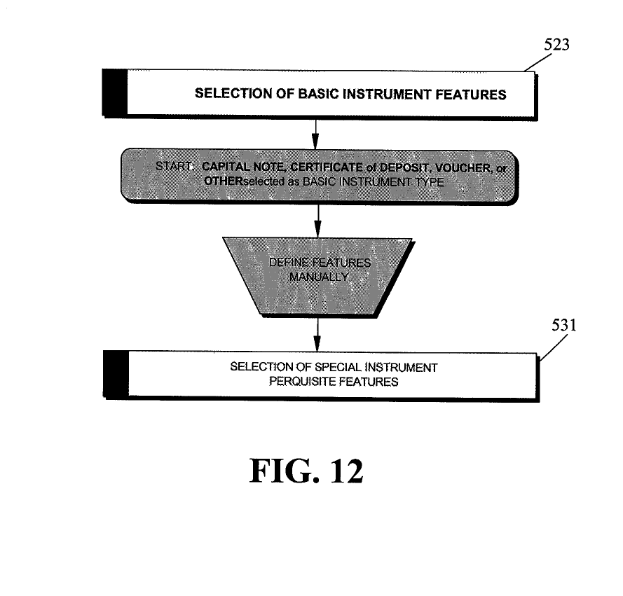

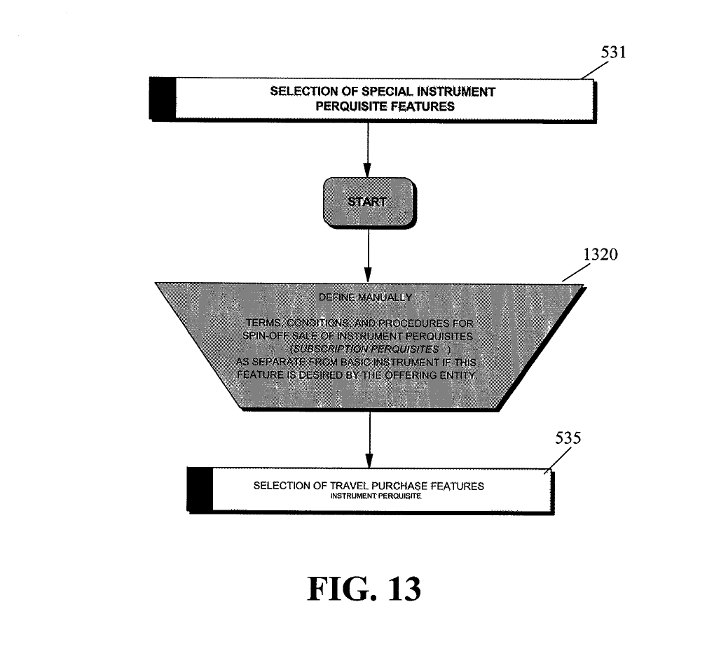

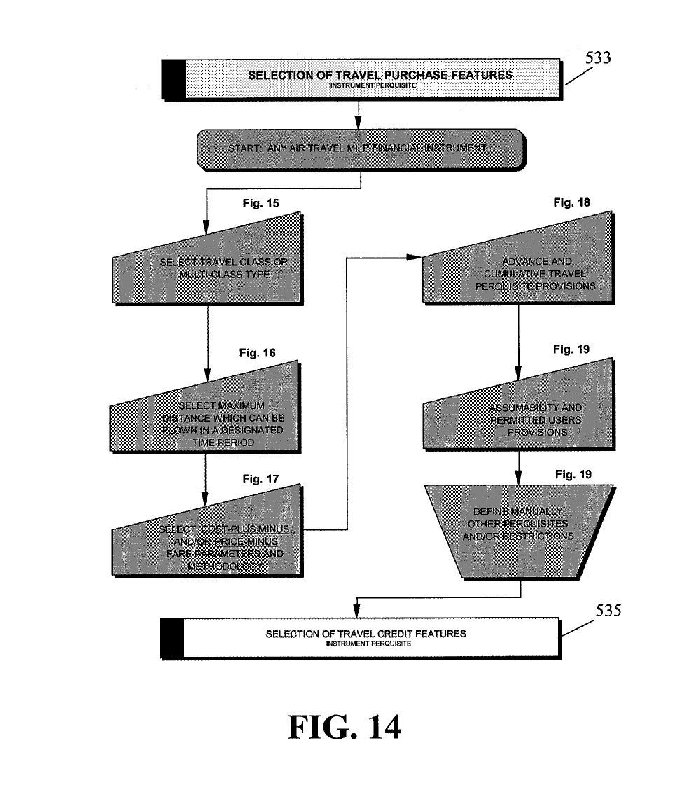

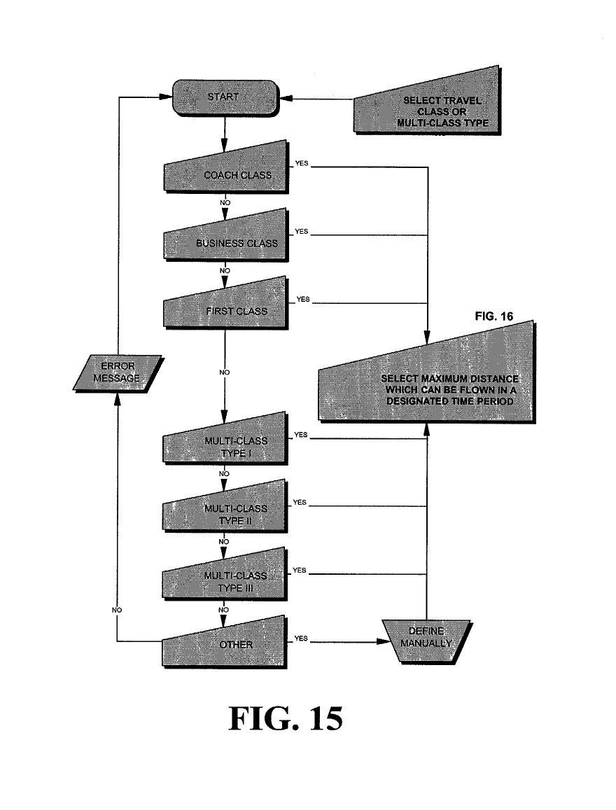

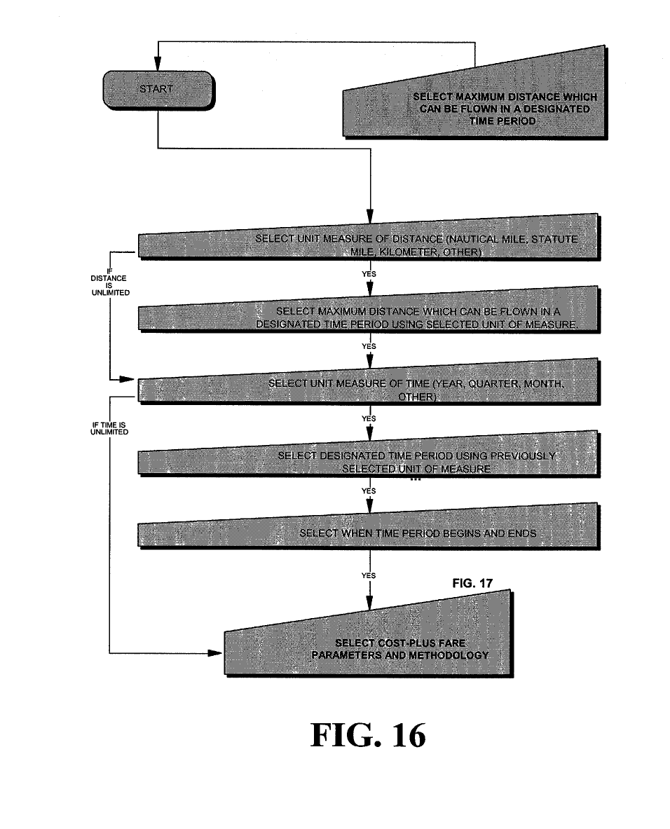

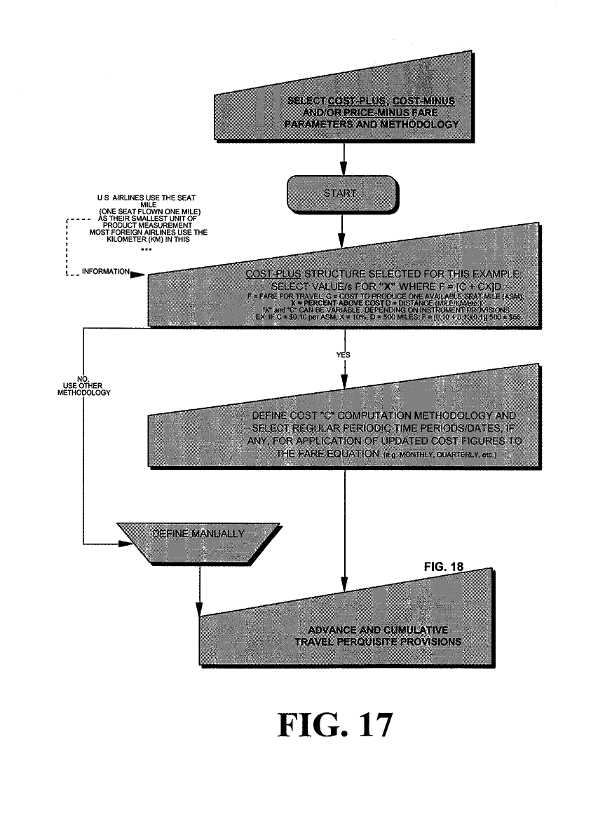

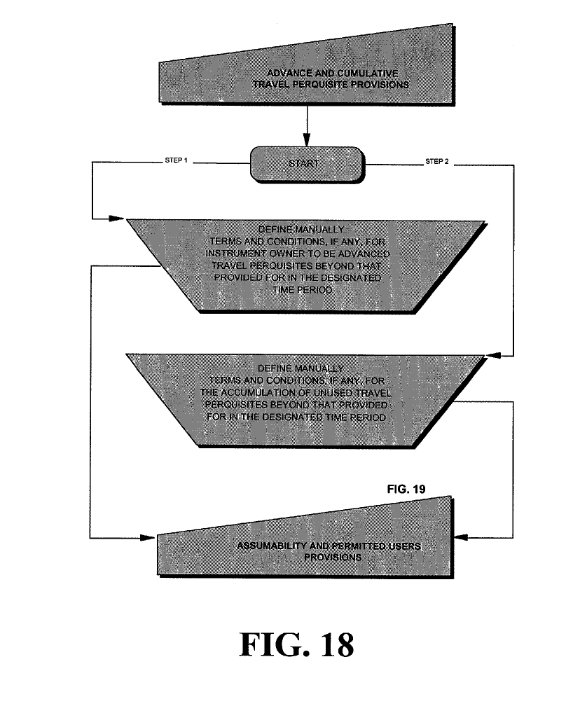

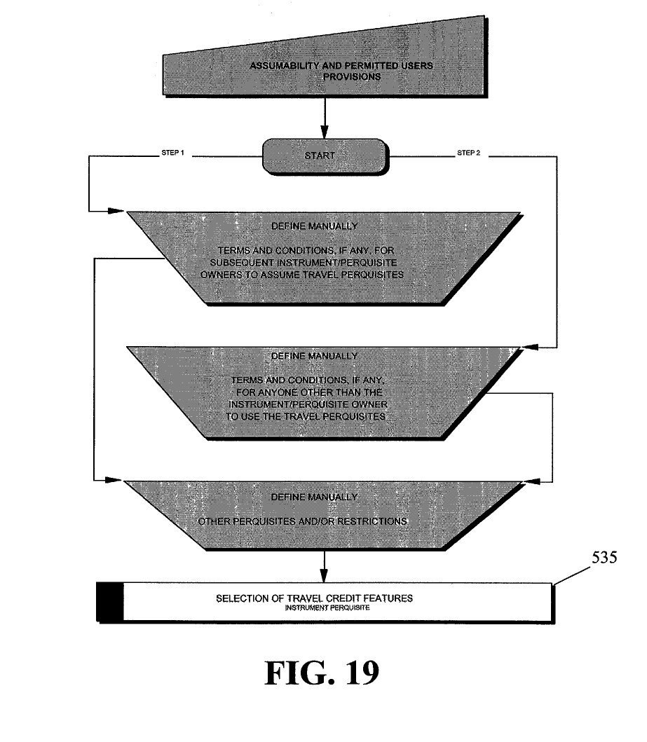

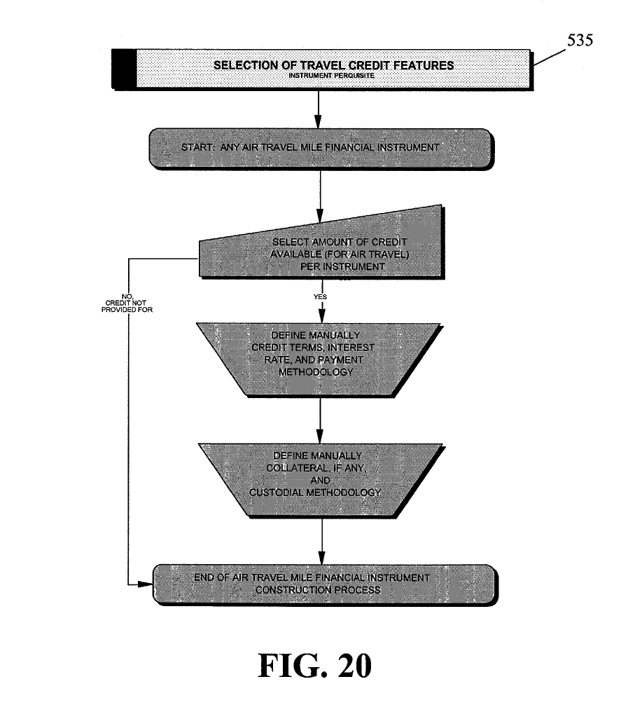

FIG. 7 depicts the processing by the subsystem 522 in selecting a basic instrument type for the air travel FI, as listed above. Once an instrument type is selected, the basic instrument features are then selected and constructed for the selected instrument type by the next subsystem 523. Examples of features and options for each instrument type are listed above and described in FIGS. 8-12. If the selection of special instrument perquisites by the subsystem 531 is to be spun off and sold separately as subscription perquisites, FIG. 13 explains the process in which the terms, conditions, and procedures for spin-off sale of instrument perquisites can be defined manually by the offering entity at 1320 prior to the selection of travel purchase features and travel credit features. Once the define process is completed, the selection of travel purchase features 533 is performed by the subsystem 531, the process for which is depicted in FIG. 14 and further explained in FIGS. 15-19. Once the selection of travel purchase features is completed, the selection of travel credit features 535 is next performed by the subsystem 531, with such process explained in FIG. 20. If the selection of the special instrument perquisites by the subsystem 531 is to remain with the air travel FI as an enhanced instrument, only the selections of travel purchase features and travel credit features described in FIGS. 14-20 are performed (i.e., the process depicted in block 1320 of FIG. 13 is not needed).

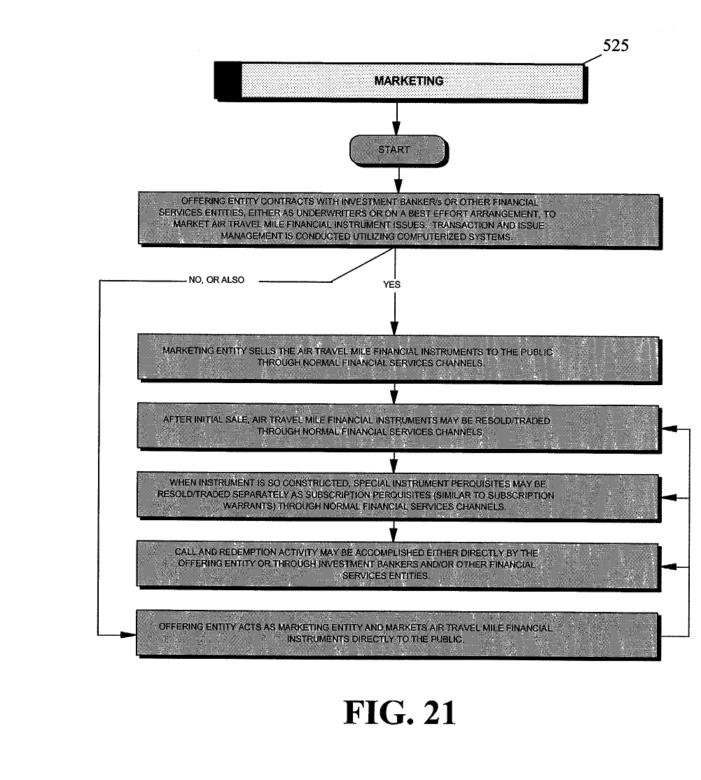

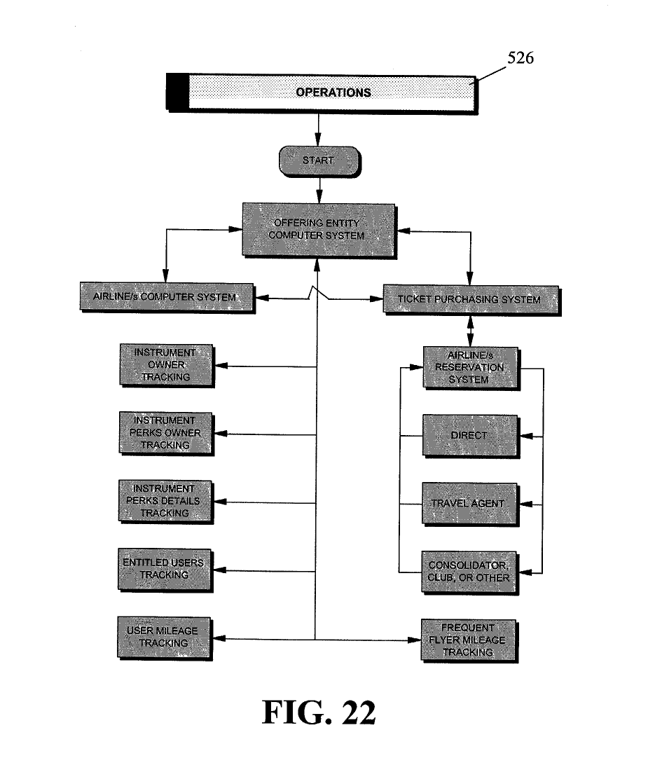

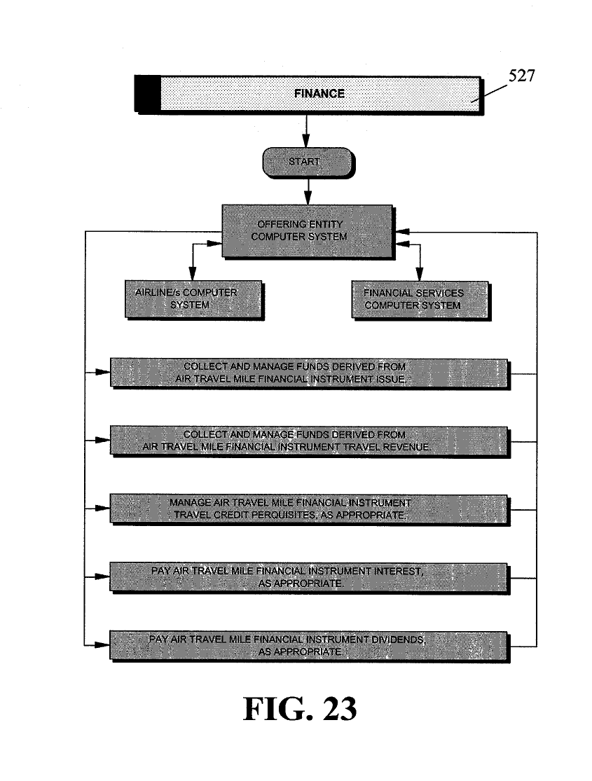

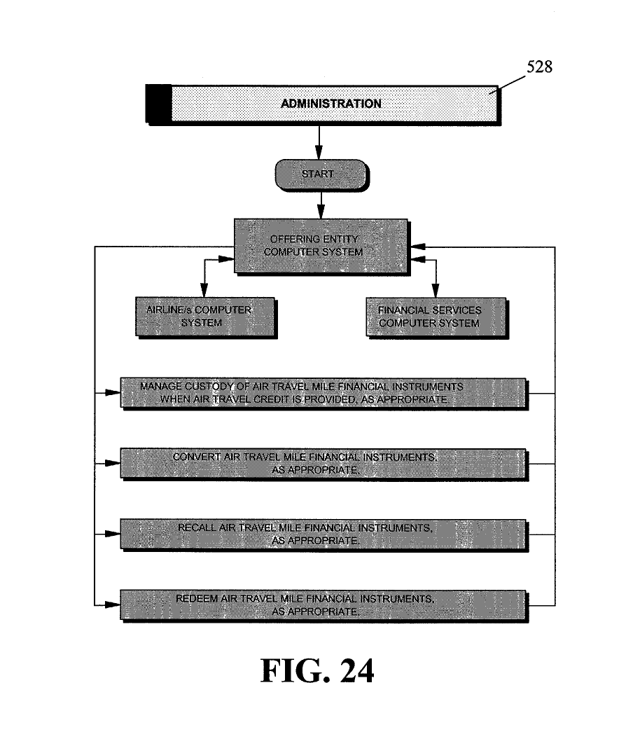

Referring back to the management system 524 shown in FIG. 5, it includes the marketing subsystem 525, which performs the process described in FIG. 21. As shown in the figure, the marketing subsystem 525 is used to market the air travel FIs directly to the public or to contract with investment bankers and other financial services entities to market the air travel FIs. FIG. 22 describes the process performed by the operations subsystem 526. FIG. 23 describes the process performed by the finance subsystem 527. Lastly, FIG. 24 describes the process performed by the administration subsystem 528.

Several examples of possible air travel FIs with associated air-travel benefit variations that can be constructed are now described. First, Table 1 shows a synopsis of an air travel bond, designed by the issuing entity to be a registered note that is not callable, that can be constructed with one of the following benefit variations: 1) coach class; 2) business class; 3) first class; 4) multi-class type 1; 5) multi-class type II; and 6) multi-class type III. It should be noted that other benefit variations are possible.

TABLE 1
Coach Class AIR TRAVEL MILE ™ Benefit:

Face amount = $1,000
Interest = Prime Rate − 2% per annum, computed and paid semi-annually.
Maturity = 30 years
Collateral = Collateral fund and Sinking fund or, other Collateral as appropriate.
Redeemable at face value + any accrued interest any time after five years.
AIR TRAVEL MILE BENEFIT = 5,000 miles per year Coach Class at cost + 15%.

Current Average Rate = 10¢ per mile = 15% over cost
Current Average Cost = 8.7¢ per mile
A typical fare: MIA to JFK = 1095 miles @ 10¢ = $109.50

CREDIT BENEFIT = $1,000 line of credit at Prime Rate + 4% for AIR TRAVEL MILE use.

Business Class AIR TRAVEL MILE ™ Benefit:

Face amount = $2,000
Interest = Prime Rate − 2% per annum, computed and paid semi-annually.
Maturity = 30 years
Collateral = Collateral fund and Sinking fund or, other Collateral as appropriate.
Redeemable at face value + any accrued interest any time after five years.
AIR TRAVEL MILE BENEFIT = 5,000 miles per year Business Class at cost + 50%.

Current Average Rate = 13.05¢ per mile = 50% over cost
Current Average Cost = 8.7¢ per mile
A typical fare: MIA to JFK = 1095 miles @ 13.05¢ = $142.90

CREDIT BENEFIT = $2,000 line of credit at Prime Rate + 4% for AIR TRAVEL MILE ™ use.

First Class AIR TRAVEL MILE ™ Benefit:

Face amount = $3,000
Interest = Prime Rate − 2% per annum, computed and paid semi-annually.
Maturity = 30 years
Collateral = Collateral fund and Sinking fund or, other Collateral as appropriate.
Redeemable at face value + any accrued interest any time after five years.
AIR TRAVEL MILE ™ BENEFIT = 5,000 miles per year First Class at cost + 75%.

Current Average Rate = 15.23¢ per mile = 75% over cost
Current Average Cost = 8.7¢ per mile
A typical fare: MIA to JFK = 1095 miles @ 15.23¢ = $166.77

CREDIT BENEFIT = $3,000 line of credit at Prime Rate + 4% for AIR TRAVEL MILE ™ use.

Multi-Class AIR TRAVEL MILE ™ Benefit - Type I

| Face amount = $1,000 | |
|---|---|
| Interest = Prime Rate − 2% per annum, computed and paid semi-annually. | |
| Maturity = 30 years | |
| Collateral = Collateral fund and Sinking fund or, other Collateral as appropriate. | |
| Redeemable at face value + any accrued interest any time after five years. | |
| AIR TRAVEL MILE ™ BENEFIT = 5,000 miles per year: | Coach Class at cost + 15%. |
| | Business Class at cost + 75%. |
| | First Class at cost + 110%. |

Current Average Cost = 8.7¢ per mile
Typical fares: MIA to JFK = 1095 miles:

| | |
|---|---|
| Coach Class: | @ 10¢ = $109.50 |
| Business Class: | @ 15.23¢ = $166.77 |
| First Class: | @ 18.27¢ = $200.06 |

CREDIT BENEFIT = $1,000 line of credit at Prime Rate + 4% for AIR TRAVEL MILE ™ use.

Multi-Class AIR TRAVEL MILE ™ Benefit - Type II

| Face amount = $2,000 | |
|---|---|
| Interest = Prime Rate − 2% per annum, computed and paid semi-annually. | |
| Maturity = 30 years | |
| Collateral = Collateral fund and Sinking fund or, other Collateral as appropriate. | |
| Redeemable at face value + any accrued interest any time after five years. | |
| AIR TRAVEL MILE BENEFIT = 5,000 miles per year: | Coach Class at cost + 10%. |
| | Business Class at cost + 50%. |
| | First Class at cost + 90%. |

Current Average Cost = 8.7¢ per mile
Typical fares: MIA to JFK = 1095 miles:

| | |
|---|---|
| Coach Class: | @ 9.57¢ = $104.79 |
| Business Class: | @ 13.05¢ $142.90 |
| First Class: | @ 16.53¢ = $181.00 |

CREDIT BENEFIT = $2,000 line of credit at Prime Rate + 4% for AIR TRAVEL MILE use.

Multi-Class AIR TRAVEL MILE ™ Benefit - Type III

| Face amount = $3,000 | |
|---|---|
| Interest = Prime Rate − 2% per annum, computed and paid semi-annually. | |
| Maturity = 30 years | |
| Collateral = Collateral fund and Sinking fund or, other Collateral as appropriate. | |
| Redeemable at face value + any accrued interest any time after five years. | |
| AIR TRAVEL MILE BENEFIT = 5,000 miles per year: | Coach Class at cost + 5%. |
| | Business Class at cost + 25%. |
| | First Class at cost + 75%. |

Current Average Cost = 8.7¢ per mile
Typical fares: MIA to JFK = 1095 miles:

| | |
|---|---|
| Coach Class: | @ 9.14¢ = $100.08 |
| Business Class: | @ 10.88¢ = $119.14 |
| First Class: | @ 15.23¢ = $166.77 |

CREDIT BENEFIT = $3,000 line of credit at Prime Rate + 4% for AIR TRAVEL MILE use.

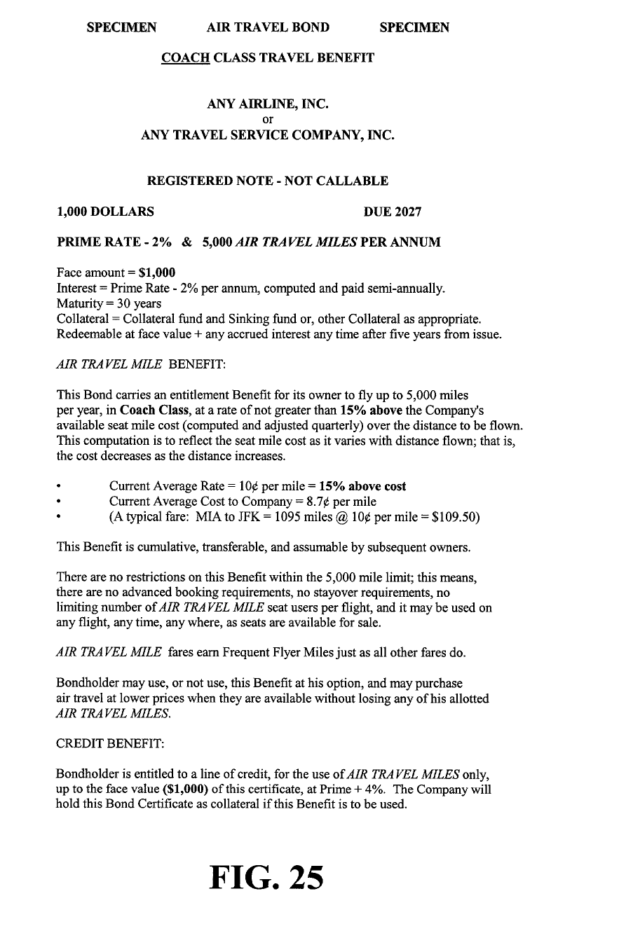

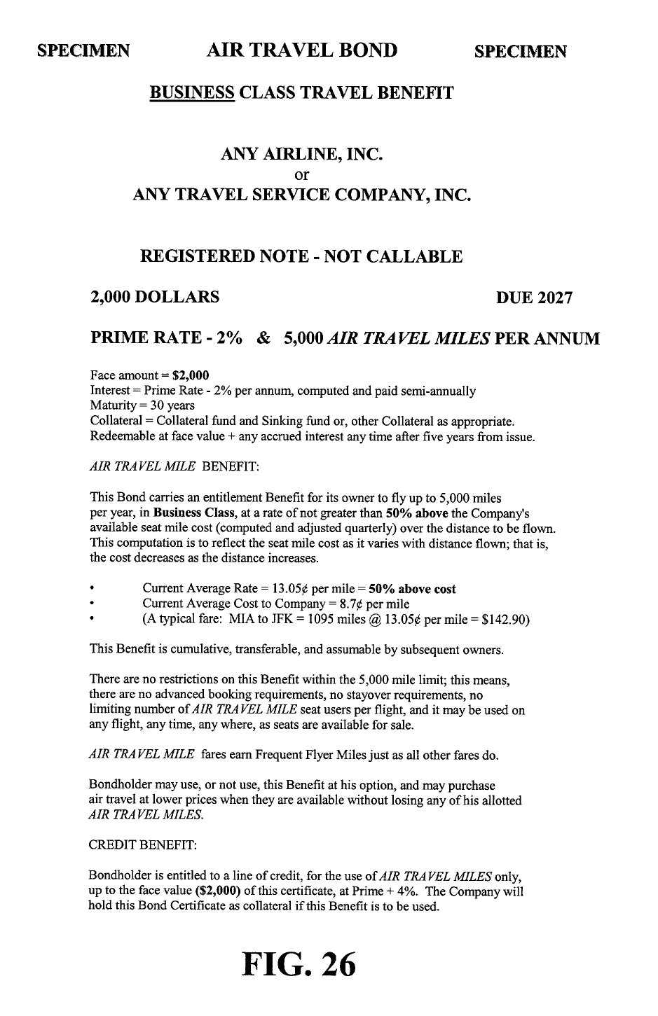

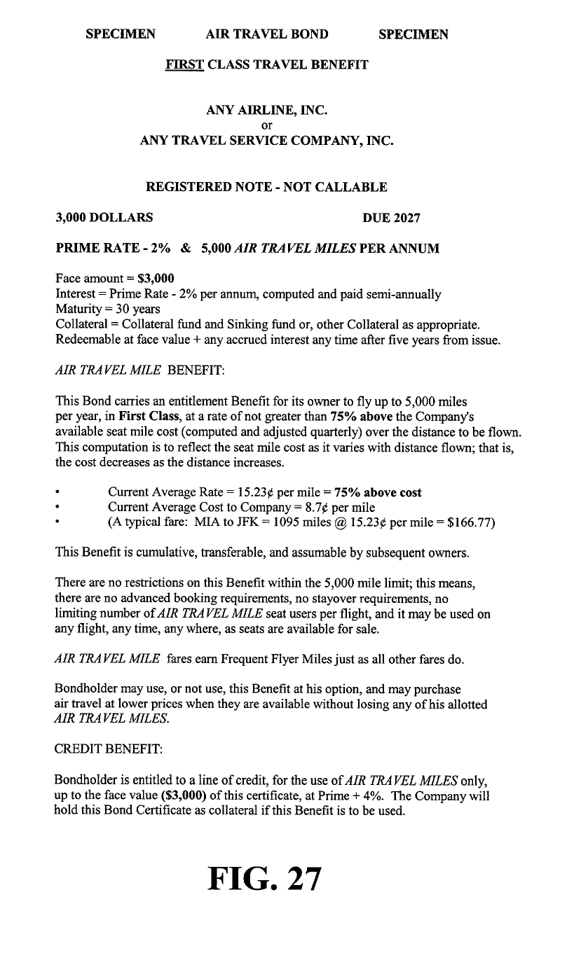

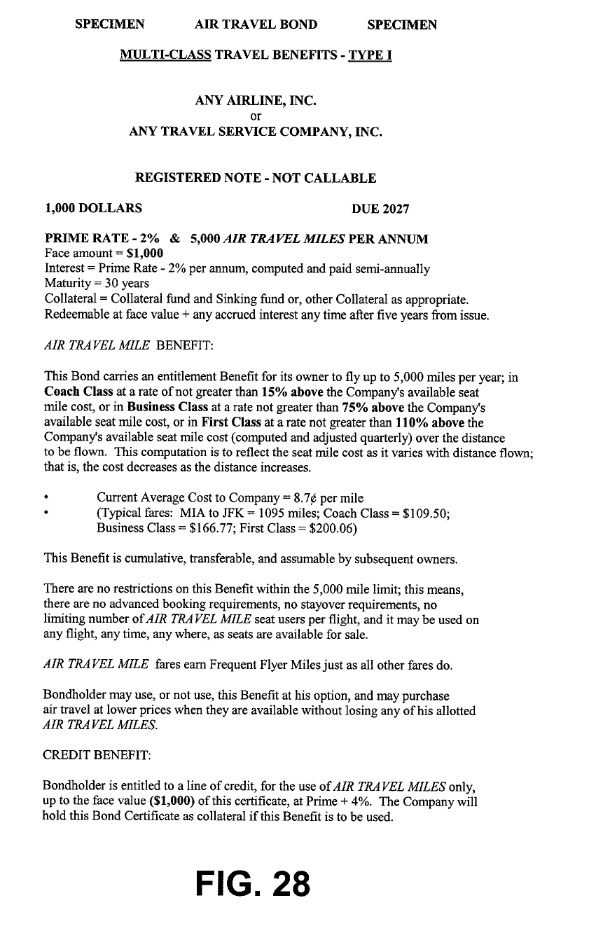

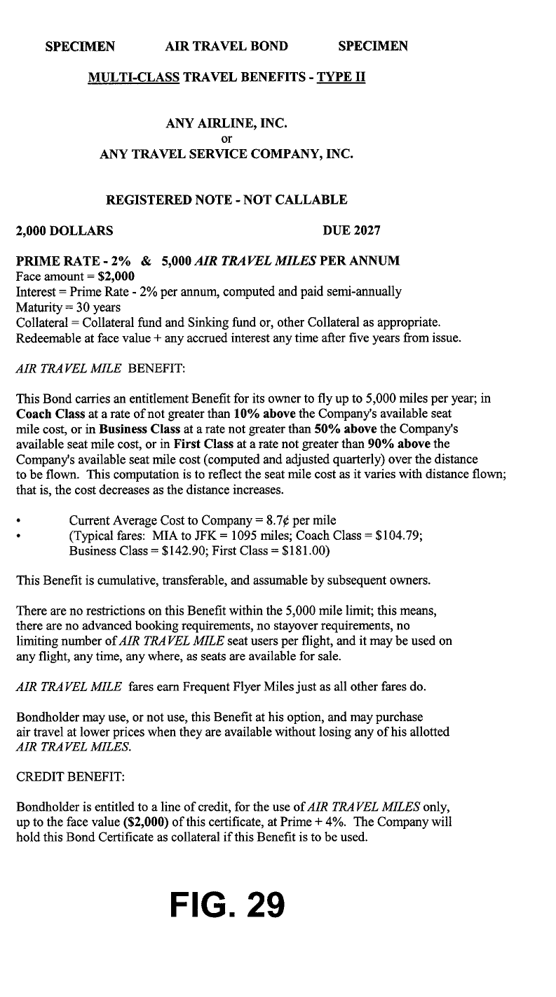

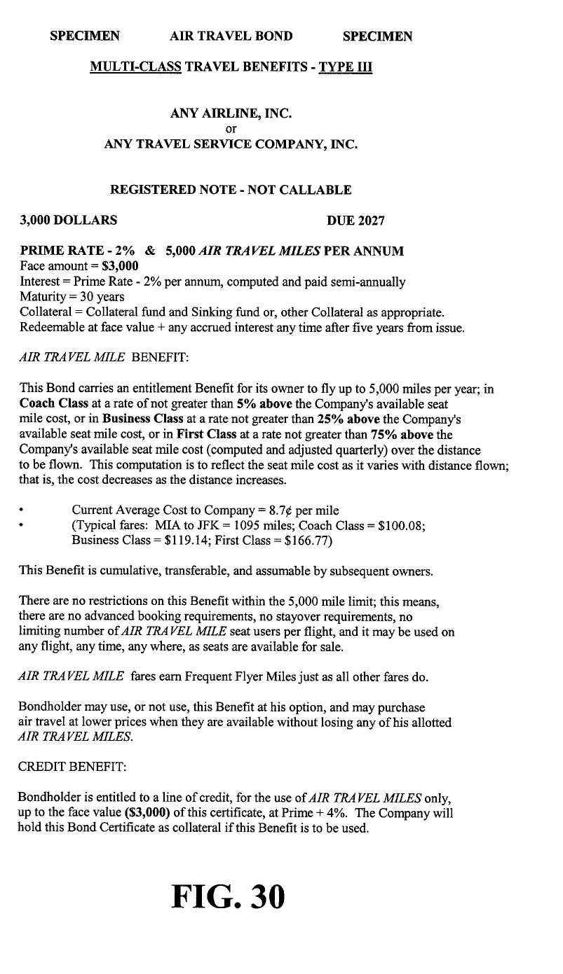

FIGS. 25-30 depict a simplistic specimen form merely showing the various components of the air travel bond constructed with each of the six benefit variations shown in Table 1.

The air travel FI in the form of, for example, air travel debenture is now explained with the same six air-travel benefit variations. The air travel debenture is similar to the air travel bond in all respects except that it is not collateralized and is therefore a junior debt instrument. This is understood in the art to be the difference between a bond and a debenture. Table 2 shows a synopsis of the air travel debenture, also designed to be a registered note that is not callable, with the six benefit variations.

TABLE 2
Coach Class AIR TRAVEL MILE ™ Benefit:

Face amount = $1,000
Interest = Prime Rate − 1% per annum, computed and paid semi-annually.
Maturity = 30 years
Collateral = None required.
Redeemable at face value + any accrued interest any time after five years.
AIR TRAVEL MILE ™ BENEFIT = 5,000 miles per year Coach Class at cost + 15%.

Current Average Rate = 10¢ per mile = 15% over cost
Current Average Cost = 8.7¢ per mile
A typical fare: MIA to JFK = 1095 miles @ 10¢ = $109.50

CREDIT BENEFIT = $1,000 line of credit at Prime Rate + 4% for AIR TRAVEL MILE ™ use.

Business Class AIR TRAVEL MILE ™ Benefit:

Face amount = $2,000
Interest = Prime Rate − 1% per annum, computed and paid semi-annually.
Maturity = 30 years
Collateral = None required.
Redeemable at face value + any accrued interest any time after five years.
AIR TRAVEL MILE ™ BENEFIT = 5,000 miles per year Business Class at cost + 50%.

Current Average Rate = 13.05¢ per mile = 50% over cost
Current Average Cost = 8.7¢ per mile
A typical fare: MIA to JFK = 1095 miles @ 13.05¢ = $142.90

CREDIT BENEFIT = $2,000 line of credit at Prime Rate + 4% for AIR TRAVEL MILE ™ use.

First Class AIR TRAVEL MILE ™ Benefit:

Face amount = $3,000
Interest = Prime Rate − 1% per annum, computed and paid semi-annually.
Maturity = 30 years
Collateral = None required.
Redeemable at face value + any accrued interest any time after five years.
AIR TRAVEL MILE ™ BENEFIT = 5,000 miles per year First Class at cost + 75%.

Current Average Rate = 15.23¢ per mile = 75% over cost
Current Average Cost = 8.7¢ per mile
A typical fare: MIA to JFK = 1095 miles @ 15.23¢ = $166.77

CREDIT BENEFIT = $3,000 line of credit at Prime Rate + 4% for AIR TRAVEL MILE ™ use.

Multi-Class AIR TRAVEL MILE ™ Benefit - Type I

| Face amount = $1,000 | |
|---|---|
| Interest = Prime Rate − 1% per annum, computed and paid semi-annually. | |
| Maturity = 30 years | |
| Collateral = None required. | |
| Redeemable at face value + any accrued interest any time after five years. | |
| AIR TRAVEL MILE ™ BENEFIT = 5,000 miles per year: | Coach Class at cost + 15%. |
| | Business Class at cost + 75%. |
| | First Class at cost + 110%. |

Current Average Cost = 8.7¢ per mile
Typical fares: MIA to JFK = 1095 miles:

| | |
|---|---|
| Coach Class: | @ 10¢ = $109.50 |
| Business Class: | @ 15.23¢ = $166.77 |
| First Class: | @ 18.27¢ = $200.06 |

CREDIT BENEFIT = $1,000 line of credit at Prime Rate + 4% for AIR TRAVEL MILE ™ use.

Multi-Class AIR TRAVEL MILE ™ Benefit - Type II

| Face amount = $2,000 | |
|---|---|
| Interest = Prime Rate − 1% per annum, computed and paid semi-annually. | |
| Maturity = 30 years | |
| Collateral = None required. | |
| Redeemable at face value + any accrued interest any time after five years. | |
| AIR TRAVEL MILE ™ BENEFIT = 5,000 miles per year: | Coach Class at cost + 10%. |
| | Business Class at cost + 50%. |
| | First Class at cost + 90%. |

Current Average Cost = 8.7¢ per mile
Typical fares: MIA to JFK = 1095 miles:

| | |
|---|---|
| Coach Class: | @ 9.57¢ = $104.79 |
| Business Class: | @ 13.05¢ = $142.90 |
| First Class: | @ 16.53¢ = $181.00 |

CREDIT BENEFIT = $2,000 line of credit at Prime Rate + 4% for AIR TRAVEL MILE ™ use.

Multi-Class AIR TRAVEL MILE ™ Benefit - Type III

| Face amount = $3,000 | |
|---|---|
| Interest = Prime Rate − 1% per annum, computed and paid semi-annually. | |
| Maturity = 30 years | |
| Collateral = None required. | |
| Redeemable at face value + any accrued interest any time after five years. | |
| AIR TRAVEL MILE ™ BENEFIT = 5,000 miles per year: | Coach Class at cost + 5%. |
| | Business Class at cost + 25%. |
| | First Class at cost + 75%. |

Current Average Cost = 8.7¢ per mile
Typical fares: MIA to JFK = 1095 miles:

| | |
|---|---|
| Coach Class: | @ 9.14¢ = $100.08 |
| Business Class: | @ 10.88¢ = $119.14 |
| First Class: | @ 15.23¢ = $166.77 |

CREDIT BENEFIT = $3,000 line of credit at Prime Rate + 4% for AIR TRAVEL MILE ™ use.

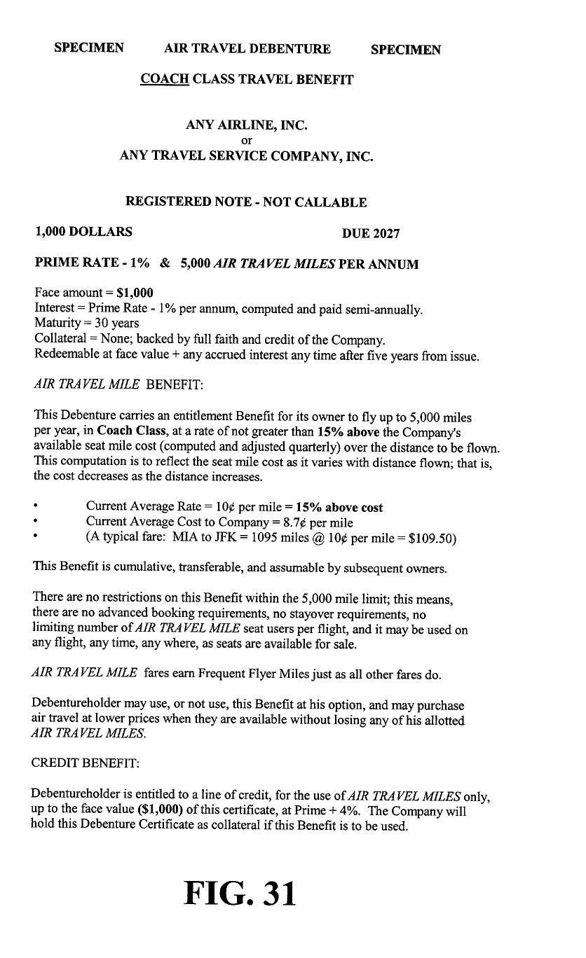

FIG. 31 depicts a simplistic specimen form of the air travel debenture with only one air-travel benefit variation, the coach class. The other variations are the same as those described earlier for the air travel bond (with the same basic numbers for computations). For brevity, the air travel bond is the only instrument shown with a complete set of specimen examples with the six air travel benefit variations.

The air travel FI in the form of, for example, air travel common share (i.e., stock) is now explained with the same six air travel benefit variations. Many of the financial benefits, and all of the travel benefits, of the air travel common share are the same as those of the air travel bond and the air travel debenture. The only differences are those that are inherent in an equity instrument (share/stock) as opposed to a debt instrument (bond and debenture). Table 3 shows a synopsis of the air travel common share, which can be a registered non-voting common stock, with the six benefit variations.

TABLE 3
Coach Class AIR TRAVEL MILE Benefit:

Par value = $1,000
Dividend = As periodically awarded by the Board of Directors
(Optional feature = Redeemable at par value any time after five years.)
AIR TRAVEL MILE ™ BENEFIT = 5,000 miles per year Coach Class at cost + 15%.

Current Average Rate = 10¢ per mile = 15% over cost
Current Average Cost = 8.7¢ per mile
A typical fare: MIA to JFK = 1095 miles @ 10¢ = $109.50

CREDIT BENEFIT = $1,000 line of credit at Prime Rate + 4% for AIR TRAVEL MILE ™ use.

Business Class AIR TRAVEL MILE Benefit:

Par value = $2,000
Dividend = As periodically awarded by the Board of Directors
(Optional feature = Redeemable at par value any time after five years.)
AIR TRAVEL MILE ™ BENEFIT = 5,000 miles per year Business Class at cost + 50%.

Current Average Rate = 13.05¢ per mile = 50% over cost
Current Average Cost = 8.7¢ per mile
A typical fare: MIA to JFK = 1095 miles @ 13.05¢ = $142.90

CREDIT BENEFIT = $2,000 line of credit at Prime Rate + 4% for AIR TRAVEL MILE ™ use.

First Class AIR TRAVEL MILE ™ Benefit:

Par value = $3,000
Dividend = As periodically awarded by the Board of Directors
(Optional feature Redeemable at par value any time after five years.)
AIR TRAVEL MILE ™ BENEFIT = 5,000 miles per year First Class at cost + 75%.

Current Average Rate = 15.23¢ per mile = 75% over cost
Current Average Cost = 8.7¢ per mile
A typical fare: MIA to JFK = 1095 miles @ 15.23¢ = $166.77

CREDIT BENEFIT = $3,000 line of credit at Prime Rate + 4% for AIR TRAVEL MILE ™ use.

Multi-Class AIR TRAVEL MILE ™ Benefit - Type I

| Par value = $1,000 | |
|---|---|
| Dividend = As periodically awarded by the Board of Directors | |
| (Optional feature Redeemable at par value any time after five years.) | |
| AIR TRAVEL MILE ™ BENEFIT = 5,000 miles per year: | Coach Class at cost + 15%. |
| | Business Class at cost + 75%. |
| | First Class at cost + 110%. |

Current Average Cost = 8.7¢ per mile
Typical fares: MIA to JFK = 1095 miles:

| | |
|---|---|
| Coach Class: | @ 10¢ = $109.50 |
| Business Class: | @ 15.23¢ = $166.77 |
| First Class: | @ 18.27¢ = $200.06 |

CREDIT BENEFIT = $1,000 line of credit at Prime Rate + 4% for AIR TRAVEL MILE ™ use.

Multi-Class AIR TRAVEL MILE ™ Benefit - Type II

| Par value = $2,000 | |
|---|---|
| Dividend = As periodically awarded by the Board of Directors | |
| (Optional feature = Redeemable at par value any time after five years.) | |
| AIR TRAVEL MILE ™ BENEFIT = 5,000 miles per year: | Coach Class at cost + 10%. |
| | Business Class at cost + 50%. |
| | First Class at cost + 90%. |

Current Average Cost = 8.7¢ per mile
Typical fares: MIA to JFK = 1095 miles:

| | |
|---|---|
| Coach Class: | @ 9.57¢ = $104.79 |
| Business Class: | @ 13.05¢ = $142.90 |
| First Class: | @ 16.53¢ = $181.00 |

CREDIT BENEFIT = $2,000 line of credit at Prime Rate + 4% for AIR TRAVEL MILE ™ use.

Multi-Class AIR TRAVEL MILE ™ Benefit - Type III

| Par value = $3,000 | |
|---|---|
| Dividend = As periodically awarded by the Board of Directors | |
| (Optional feature = Redeemable at par value any time after five years.) | |
| AIR TRAVEL MILE ™ BENEFIT = 5,000 miles per year: | Coach Class at cost + 5%. |
| | Business Class at cost + 25%. |
| | First Class at cost + 75%. |

Current Average Cost = 8.7¢ per mile
Typical fares: MIA to JFK = 1095 miles:

| | |
|---|---|
| Coach Class: | @ 9.14¢ = $100.08 |
| Business Class: | @ 10.88¢ = $119.14 |
| First Class: | @ 15.23¢ = $166.77 |

CREDIT BENEFIT = $3,000 line of credit at Prime Rate + 4% for AIR TRAVEL MILE ™ use.

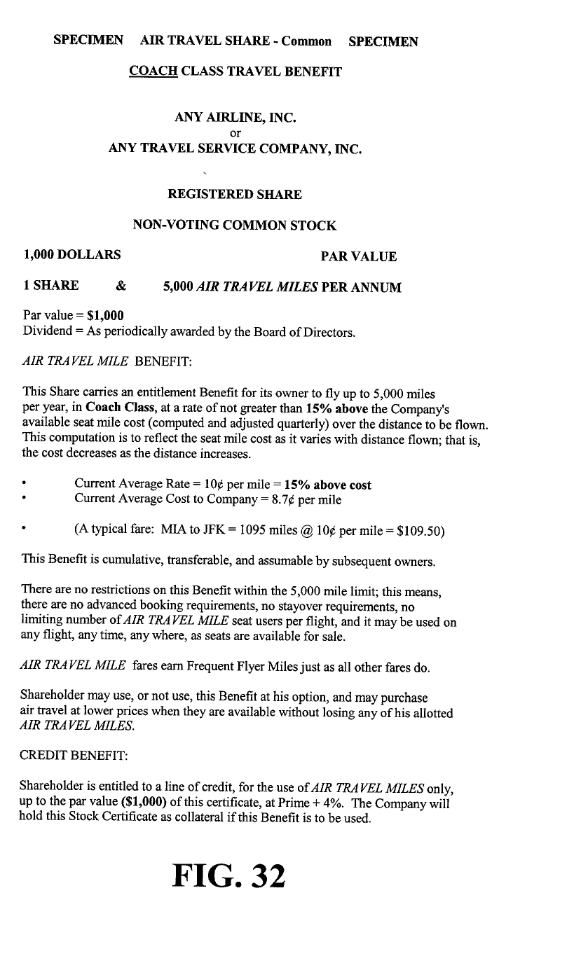

Again, for brevity, FIG. 32 depicts a simplistic specimen form of the air travel common share with only one air-travel benefit variation, the coach class.

The air travel FI in the form of, for example, air travel preferred share (i.e., stock) is now explained with the same six air travel benefit variations. Many of the financial benefits, and all of the travel benefits, of the air travel common share are the same as those of the air travel bond and the air travel debenture. The only differences are those that are inherent in an equity instrument (share) as opposed to a debt instrument (bond and debenture). Also, the only differences between the preferred share and the common share described earlier are the regular dividends required for the preferred and its senior status as an equity instrument. Table 4 shows a synopsis of the air travel preferred share, which can be a registered non-voting preferred stock, with the six benefit variations.

TABLE 4
Coach Class AIR TRAVEL MILE ™ Benefit:

Par value = $1,000
Dividend = Prime Rate − 2% per annum, cumulative, computed and paid semi-annually.
(Optional feature = Redeemable at par value any time after five years.)
AIR TRAVEL MILE ™ BENEFIT = 5,000 miles per year Coach Class at cost + 15%.

Current Average Rate = 10¢ per mile = 15% over cost
Current Average Cost = 8.7¢ per mile
A typical fare: MIA to JFK = 1095 miles @ 10¢ = $109.50

CREDIT BENEFIT = $1,000 line of credit at Prime Rate + 4% for AIR TRAVEL MILE ™ use.

Business Class AIR TRAVEL MILE ™ Benefit:

Par value = $2,000
Dividend = Prime Rate − 2% per annum, cumulative, computed and paid semi-annually.
(Optional feature = Redeemable at par value any time after five years.)
AIR TRAVEL MILE ™ BENEFIT = 5,000 miles per year Business Class at cost + 50%.

Current Average Rate = 13.05¢ per mile = 50% over cost
Current Average Cost = 8.7¢ per mile
A typical fare: MIA to JFK 1095 miles @ 13.05¢ = $142.90

CREDIT BENEFIT = $2,000 line of credit at Prime Rate + 4% for AIR TRAVEL MILE ™ use.

First Class AIR TRAVEL MILE ™ Benefit:

Par value = $3,000
Dividend = Prime Rate − 2% per annum, cumulative, computed and paid semi-annually.
(Optional feature = Redeemable at par value any time after five years.)
AIR TRAVEL MILE ™ BENEFIT = 5,000 miles per year First Class at cost + 75%.

Current Average Rate = 15.23¢ per mile = 75% over cost
Current Average Cost = 8.7¢ per mile
A typical fare: MIA to JFK 1095 miles @ 15.23¢ = $166.77

CREDIT BENEFIT = $3,000 line of credit at Prime Rate + 4% for AIR TRAVEL MILE ™ use.

Multi-Class AIR TRAVEL MILE ™ Benefit - Type I

| Par value = $1,000 | |
|---|---|
| Dividend = Prime Rate − 2% per annum, cumulative, computed and paid semi-annually. | |
| (Optional feature = Redeemable at par value any time after five years.) | |
| AIR TRAVEL MILE ™ BENEFIT = 5,000 miles per year: | Coach Class at cost + 15%. |
| | Business Class at cost + 75%. |
| | First Class at cost + 110%. |

Current Average Cost = 8.7¢ per mile
Typical fares: MIA to JFK = 1095 miles:

| | |
|---|---|
| Coach Class: | @ 10¢ = $109.50 |
| Business Class: | @ 15.23¢ = $166.77 |
| First Class: | @ 18.27¢ = $200.06 |

CREDIT BENEFIT = $1,000 line of credit at Prime Rate + 4% for AIR TRAVEL MILE ™ use.

Multi-Class AIR TRAVEL MILE ™ Benefit - Type II

| Par value = $2,000 | |
|---|---|
| Dividend = Prime Rate − 2% per annum, cumulative, computed and paid semi-annually. | |
| (Optional feature = Redeemable at par value any time after five years.) | |
| AIR TRAVEL MILE ™ BENEFIT = 5,000 miles per year: | Coach Class at cost + 10%. |
| | Business Class at cost + 50%. |
| | First Class at cost + 90%. |

Current Average Cost = 8.7¢ per mile
Typical fares: MIA to JFK = 1095 miles:

| | |
|---|---|
| Coach Class: | @ 9.57¢ = $104.79 |
| Business Class: | @ 13.05¢ = $142.90 |
| First Class: | @ 16.53¢ = $181.00 |

CREDIT BENEFIT = $2,000 line of credit at Prime Rate + 4% for AIR TRAVEL MILE ™ use.

Multi-Class AIR TRAVEL MILE ™ Benefit - Type III

| Par value = $3,000 | |
|---|---|
| Dividend = Prime Rate − 2% per annum, cumulative, computed and paid semi-annually. | |
| (Optional feature = Redeemable at par value any time after five years.) | |
| AIR TRAVEL MILE ™ BENEFIT = 5,000 miles per year: | Coach Class at cost + 5%. |
| | Business Class at cost + 25%. |
| | First Class at cost + 75%. |

Current Average Cost = 8.7¢ per mile
Typical fares: MIA to JFK = 1095 miles:

| | |
|---|---|
| Coach Class: | @ 9.14¢ = $100.08 |
| Business Class: | @ 10.88¢ = $119.14 |
| First Class: | @ 15.23¢ = $166.77 |

CREDIT BENEFIT = $3,000 line of credit at Prime Rate + 4% for AIR TRAVEL MILE ™ use.

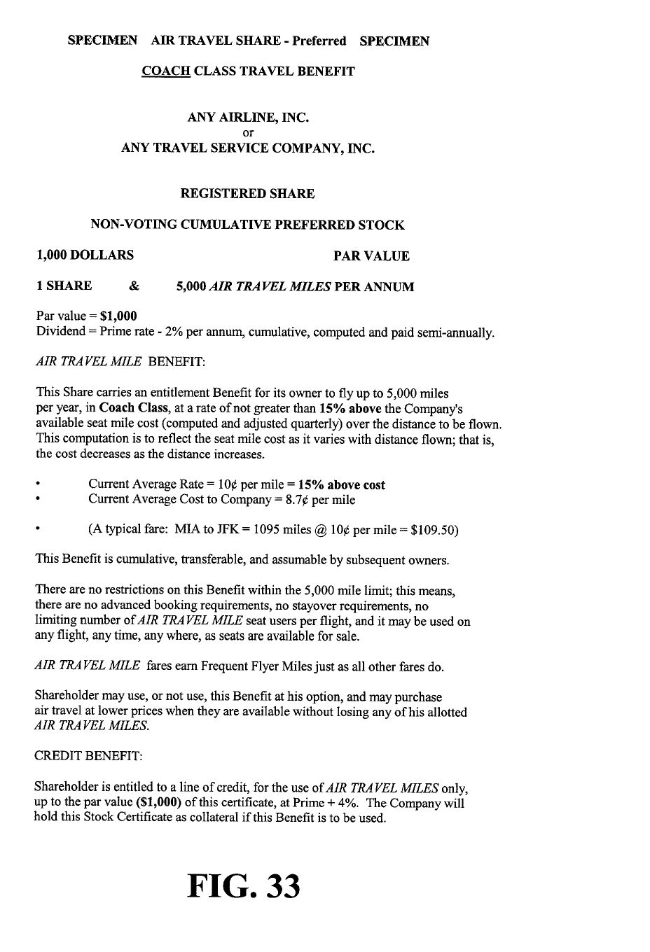

Again, for brevity, FIG. 33 depicts a simplistic specimen form of the air travel preferred share with only one air-travel benefit variation, the coach class.

The structure and components of all benefit variations can be adjusted as required to obtain both optimum marketing and financial results as desired by the airline or entity issuing the air travel FI. As understood in the art, the air travel bond and debenture types of air travel FI are financial instruments representing the debt capital to the issuing entity, with no dilution of equity. Both require regular interest payments and must be repaid in full at maturity. While the bond must be collateralized, the debenture needs not be. Both are redeemable at face value upon demand by the bondholder or debenture holder, respectively, anytime after a predetermined period of time from the date of issue as set by the issuing entity. This component, as with all other features and components of the air travel bond and debenture, is variable and optional to the issuing entity enhance the marketability of the instrument. According to one embodiment of the present invention, interest payments can be indexed to the Prime Rate or London Inter-Bank Offer Rate (LIBOR) so that neither the bondholder nor the issuer is concerned with having to outmaneuver prevailing interest rates; therefore, it is not necessary that it be callable. However, as with all other components, the interest rate and the interest rate index can be set as desired by the issuing entity, and the instrument can be callable.

For the common and preferred shares, as understood in the art, they represent equity capital to the issuing entity. There is no dilution of existing equity as a consequence, but net asset value is advantageously increased for existing shareholders. While the common share may not require regular dividend payments except as awarded at the discretion of the board of directors of issuing entity, the preferred share may require regular dividend payments. As a sales incentive for the consumer, and for additional incentive for the airline to maintain its efficiency, quality, and financial strength, the common and preferred shares can also be structured with a similar redeemable feature as that described earlier for the air travel bond and debenture. This feature can have a stabilizing effect on the stock's trading price in the secondary market.

According to one embodiment of the present invention, air travel benefits are indexed to the cost of operations so that even as changing economic conditions impact the air transport industry, the bondholder and issuer maintain the same relative financial relationship. Even though the airline is operating on a cost-plus basis as a result of this indexing, it must still maintain its efficiency and quality of service. If it does not, and the bondholder becomes dissatisfied, he can sell the instrument, redeem it at face value after a pre-set time, or take his business elsewhere, depending on the airline's form of participation.

The air travel FIs can be purchased through normal financial channels such as licensed securities broker/dealers or directly from the issuing entity, which can be the particular airline itself, a travel agent, or a travel service company. Purchasers of the air travel FIs can make use of the travel benefits derived from the air travel FIs by purchasing airline tickets in a normal manner, i.e., through travel agents, airlines, travel service companies, Internet, etc. After properly identifying oneself as an air travel FI owner to a ticket-selling entity, the special ATM airfare is automatically computed and provided by the mechanisms shown in FIGS. 4 and 5 based on the benefit terms contracted in the purchased air travel FI.

Travel agent compensation when selling an ATM fare may remain the same as when selling any other fare and is predicated on the existing agreement between the agent and the respective airline. In other words, when a travel agent's client owns an ATM instrument and is utilizing his own instrument's travel benefits, and if the agent books the flight for the client, the agent is entitled to his normal compensation from the airline. Additional compensation may come, however, when the agent owns an ATM instrument. In this instance, the agent may book a flight utilizing the agent's own instrument's travel benefits, pay the airline the designated ATM fare, charge the client a premium above that fare, and also collect the normal agent compensation from the airline. Hotels, car rental companies, and other merchants/businesses can participate in the air travel FI program by purchasing air travel FIs and awarding the travel benefits to their customers in a similar fashion to their purchasing of frequent flyer miles for their customers now. These businesses will now own a liquid financial asset for its money spent, and the consumer will still have the frequent flyer miles after using his air travel miles.

The air travel FI owner can easily compute the ATM fare for planning purposes by multiplying the number of miles to be flown by a known rate per mile for a particular chosen class as provided on the air travel FI as part of the travel benefits. In an era of electronic ticketing and paperless travel, one can be provided with software as part of the purchase of the air travel FI for installation on one's personal computer, PDA, or other computing devices for easy calculation of the ATM fares. Alternatively, one can be provided with an interactive phone number as part of the purchase of the air travel FI, so that one can call in with a touch-tone telephone, enter the requisite information on the phone keypad to obtain the calculated ATM fare. Because the air travel FI owners are provided with provisions to easily calculate the ATM fares in advance, and well into the future, they can better budget their travel expenses, which contributes more to the overall positive experience of the air travel FI owners as investors and airline passengers and helps foster brand loyalty among these captivated consumers.

If there is a fare offered by the same airline that is lower than the special ATM airfare, the air travel FI owner retains the option to purchase the lower airfare and save the ATM benefits for a future trip. This is because the air travel FI owner possesses the air travel FI, and he/she is not obliged to use it for all air travel. It is more advantageous for the owner to apply the ATM benefits to obtain lower fare and/or avoid undesired airline-imposed travel restrictions.

According to one embodiment of the present invention, the travel benefits provided by the air travel FI has few or no restrictions, depending on the desire of the issuing entity. For instance, the benefits can be cumulative, transferable, and assumable by a subsequent owner that purchased it through a secondary market. For the cumulative feature, if any of the mileage benefit (e.g., 5000 ATMs per year) goes unused in any given year, or a predetermined period of time, it is cumulative and may be utilized in subsequent years for as long as the enhanced FI is in force. For the transfer feature, it is not required that the owner of the instrument be the only person to use the mileage benefit, or that he/she uses it at all. The owner can transfer his benefit to other designated people at his/her discretion, e.g., family members, friends, employees, clients, etc., and several people may use the benefit from one instrument at the same time. This transfer feature makes the air travel FI especially attractive to large corporate customers for use by their personnel for business travel. Because air travel FIs are registered securities and may be traded just as other similar securities are traded, they can be sold and traded in the secondary market. Hence, the transfer feature is further attractive to resellers (e.g., travel agents, wholesalers) who can turn around and resell the air travel FIs loaded with perquisites to their customers at a premium. Again, if applicable, the perquisites of the air travel FIs can also be spun-off as subscription perquisites for separate sales to take advantage of the transfer feature. For the assumable feature, when the instrument is sold, the new owner is entitled to assume some or all current and accrued benefits, as desired by the issuing entity to make the air travel FI more marketable.

The aforementioned features make the instrument highly attractive and more marketable, especially to individuals, families, groups, businesses, and government entities with significant travel budgets and needs for accurate travel-cost forecasting and accurate budgeting. As mentioned earlier, these features can provide additional factors for computing instrument value in the secondary market. According to an embodiment of the present invention, other benefits offered by the airline, such as frequent flyer benefits, are not affected in any way by the introduction of perquisites provided by the air travel FI. Because air travel FI passengers are profit-paying passengers, they are also entitled to earn and redeem frequent flyer benefits and any other benefits offered by the airlines to its regular customers.

The travel benefits can also be unrestricted within the mileage limit of the air travel FI. Hence, there are no advanced booking requirements, no stay over requirements, no limiting number of ATM seat users per flight, and it may be used on any flight, anytime, and anywhere that plane seats are available for sale.

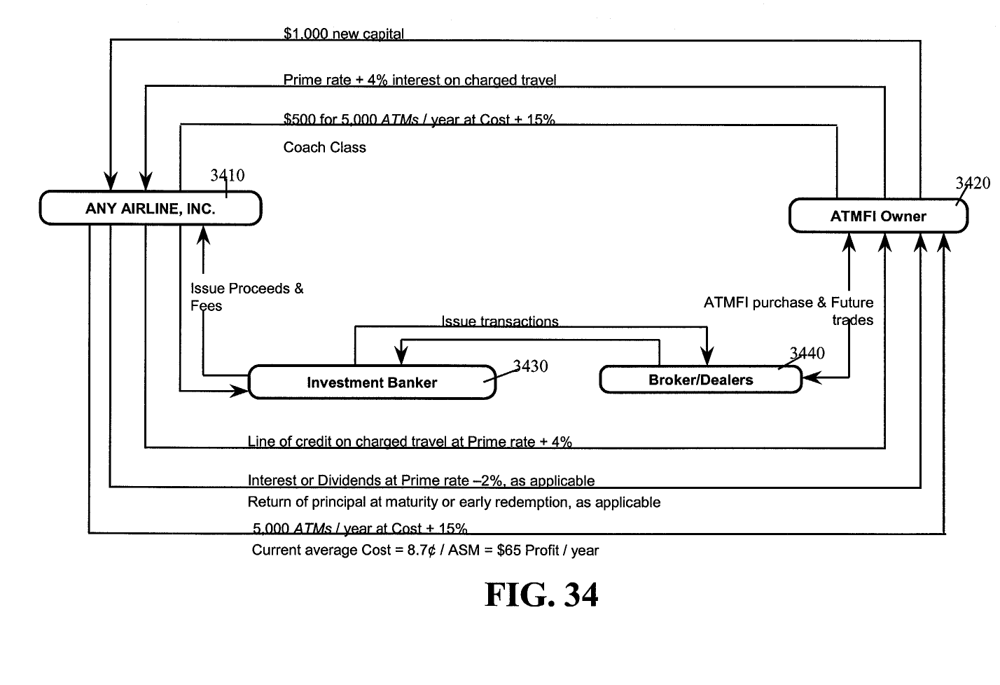

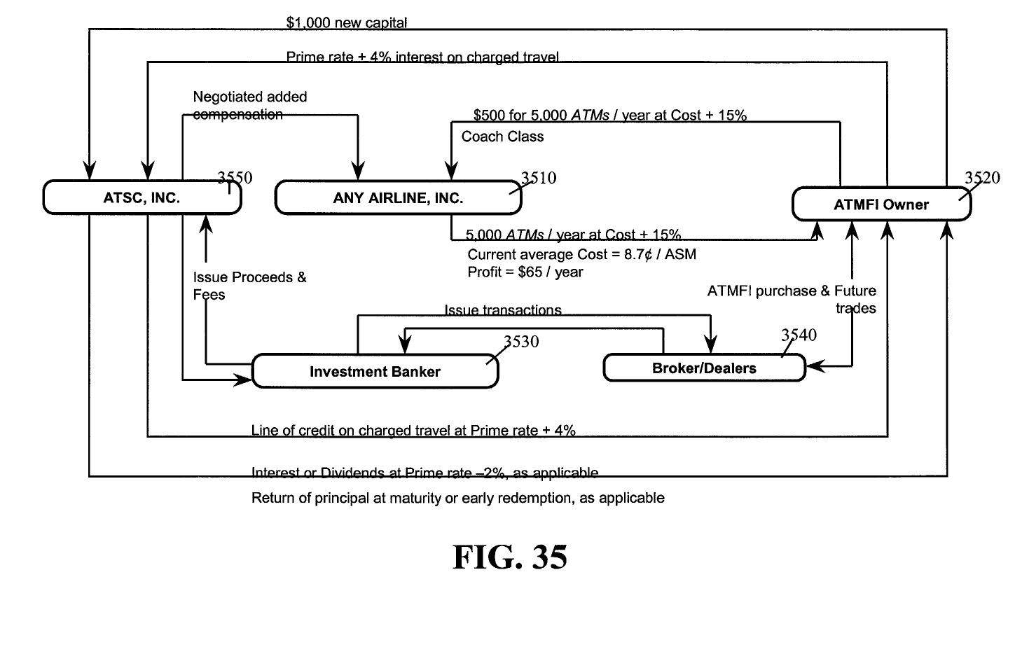

Analogous to FIG. 6, FIGS. 34 and 35 provide simplified visual representations of the flow of capital and services in an air travel FI transaction and utilization. For simplicity, only the $1,000 coach class instrument is represented in the figures and the instrument is of a debt type (e.g., bond, debenture, etc.). FIG. 34 shows the implementation of the air travel FI scheme by an airline 3410, i.e., the airline itself acts as the entity issuing the air travel FIs to consumers. The airline 3410 can represent a single airline or an alliance/consortium of airlines, foreign and/or domestic. If a single airline issues the instrument, without code share partners, travel benefit use will probably be on that airline only. If a single airline issues the instrument, with code share partners, travel benefit use will probably be on that airline plus its code share partners. If an airline alliance issues the instrument, travel benefit use will probably be on all members of the alliance. If a travel service company (American Express) issues the instrument, travel benefit use will probably be on many airlines. A universal use of the travel benefits may also be possible.

As shown in FIG. 34, the airline 3410 issues air travel FIs to an investment banker 3430 for trading. Broker/dealers 3440 can then obtain the enhanced financial instruments from the investment banker 3430 for selling, trading, and/or brokering with a prospective consumer 3420, which becomes the owner 3420 upon purchasing of an air travel FI issued by the airline 3410. The air travel FI owner 3420 can be a single individual consumer, a group of individual consumers banded together, institutional investors, one or more other broker/dealers, or a combination of one or more of the aforementioned. FIG. 34 is further described in view of FIG. 1. The air travel FI carries the typical financial benefits, including: interest or dividends at 2% less than prime rate and interested or dividends at 2% less than the prime rate, if applicable. The air travel FI also offers a credit benefit in the form of a line of credit or charged travel at prime rate+4%. The air travel FI further offers a travel benefit in the form of 5000 ATMs per year at cost plus 15%. In return, the owner 3420 provides the airline 1010 with $1000 in capital for the purchase of the air travel FI at face amount. If the owner took advantage of the line of credit offered to it, the owner must also pay interest at Prime+4% on the charged travel. If the owner took advantage of the travel benefit, the owner must also pay the appropriate amount corresponding to the number of miles traveled at cost plus 15%. FIG. 35 is similar to FIG. 34 with like components having like labels, except that the air travel FI scheme is now implemented by a third-party such as a travel service company represented by the new block 3550. In this case, the travel service company 3550 serves as the entity issuing the air travel FI based on communication with the airline 3510.

The present invention has been described with reference to the enhanced FI as the specific air travel FI being a debt or equity instrument with air-travel benefits, credit benefits, and optional subscription perquisites. However, the enhanced FI can be an instrument representing a financial asset other than a debt or equity instrument, such as a voucher. Additionally, the enhanced FI has universal and unlimited applications to any enterprise or entity and for any products or services that can be conferred on the purchaser of the instrument in addition to those financial benefits normally associated with a corresponding traditional type of instrument. For instance, the enhanced FI can be constructed to confer sea-travel and land-travel (e.g., train, bus, automobile) benefits. The synopsis of a enhanced FI for sea-travel or land-travel benefits can be the same as those shown in Tables 1-4, except for the rate per unit distance to be charged to the enhanced FI owner. The enhanced FI can also be constructed to confer a combination of air-travel, land-travel, and sea-travel benefits. To extend further, the enhanced FI can be designed to confer other benefits such discounts (e.g., 20% off purchase, buy-one-get-one-free, 20% off brokerage services, etc.) at merchants for tangible products and/or services in addition to the normal financial benefits.

Although the invention has been described with reference to these preferred embodiments, other embodiments could be made by those in the art to achieve the same or similar results. Variations and modifications of the present invention will be apparent to one skilled in the art based on this disclosure, and the present invention encompasses all such modifications and equivalents.

1. A financial instrument comprising:
a first value designating a purchasing cost of the instrument; and
a first perquisite giving a purchaser of the instrument a right to purchase a service and/or tangible product offered by an entity issuing the instrument at a predetermined discounted rate;
wherein the instrument represents a financial asset to the purchaser.

2. The financial instrument of claim 1, wherein the instrument represents the debt capital, and the first value represents a debt owed to the purchaser of the instrument by the issuing entity.

3. The financial instrument of claim 1, wherein the instrument represents the equity capital, and the first value represents an equity value to the issuing entity as obtained by the purchased of the instrument.

4. The financial instrument of claim 2, further comprising:
a second value designating a predetermined interest rate to be paid to the instrument purchaser periodically for the debt owed by the issuing entity; and
a maturity time after which the instrument purchaser can recover the debt owed by the issuing entity.

5. The financial instrument of claim 4, wherein the instrument is redeemable anytime after a predetermined time period.

6. The financial instrument of claim 1, further comprising a second perquisite giving the instrument purchaser a line of credit to purchase the service and/or tangible product offered by the issuing entity.

7. The financial instrument of claim 6, further comprising a third perquisite giving the instrument purchaser a right to sell off the first perquisite separately.

8. The financial instrument of claim 1, further comprising a second perquisite giving the instrument purchaser a right to sell off the first perquisite separately.

9. The financial instrument of claim 3, further comprising:
a second value designating a predetermined dividend to be paid to the instrument purchaser periodically as an equity holder in the issuing entity.

10. The financial instrument of claim 1, wherein the tangible product is an air-travel benefit that allows the instrument purchaser to fly up to a set amount of units of distance, in a set period of time, and at a set cost per unit of flown distance.

11. The financial instrument of claim 10, wherein the set amount of units of distance, the set period of time, and the set cost per unit of flown distance are determined by the issuing entity.

12. The financial instrument of claim 11, wherein the issuing entity is an airline providing the air-travel benefit to the instrument purchaser.

13. The financial instrument of claim 11, wherein the air-travel benefit is provided by an entity other than the issuing entity.

14. A method for providing a financial instrument to a prospective purchaser, comprising:
constructing the financial instrument to represent a debt capital or an equity capital instrument and to include a first value designating a purchasing cost of the instrument and a first perquisite providing a right to purchase a service and/or tangible product at a predetermined discounted rate upon a purchase of the constructed instrument;
marketing the constructed instrument; and
receiving a first capital from a sale of the constructed instrument as a result of the marketing.

15. The method of claim 14, wherein marketing the constructed instrument comprises marketing the constructed instrument directly;

16. The method of claim 14, wherein marketing the constructed instrument comprises marketing the constructed instrument through a financial services entity.

17. The method of claim 14, further comprising:
receiving a request to purchase the service and/or tangible product based on the first perquisite;
receiving a second capital for the purchase of the service and/or tangible product; and
providing the purchased service and/or tangible product.

18. The method of claim 17, wherein constructing the enhanced financial instrument comprises negotiating with a producer of the service and/or tangible product; and
providing the purchased service and/or tangible product comprises the producer providing the purchased service and/or tangible product.

19. The method of claim 18, further comprising:
providing compensation to the producer based on the received second capital for the purchased service and/or tangible product provided by the producer.

20. The method of claim 17, wherein the first capital is received from a first source, and the second capital is received from a second source.

21. The method of claim 20, wherein the first source and the second source are the same.

22. The method of claim 20, wherein the first source is different from the second source.

23. The financial instrument of claim 1, wherein the predetermined discounted rate is based on a cost-plus scheme.

24. The financial instrument of claim 1, wherein the predetermined discounted rate is based on a cost-minus scheme.

25. The financial instrument of claim 1, wherein the predetermined discounted rate is based on a price-minus scheme.

26. A system for constructing and managing a financial instrument (FI), comprising:
a first system that constructs the FI as a debt capital or an equity capital instrument with at least one feature and at least one perquisite that provides a right to purchase an offered service and/or tangible product at a predetermined discounted rate upon a purchase of the constructed instrument; and
a second system that manages a transaction and utilization of the constructed instrument.

27. The system of claim 26, wherein the first system comprises:
a first subsystem that selects a financial instrument type for constructing the enhanced FI, wherein the selected type for the FI determines whether the enhanced FI is a debt instrument or an equity instrument.

28. The system of claim 27, wherein the first system further comprises:
a second subsystem that selects at least one feature to be associated with the selected type for constructing the FI;

29. The system of claim 28, wherein the first system further comprises:
a third subsystem that constructs the at least one perquisite.

30. The system of claim 26, wherein the second system comprises:
a marketing subsystem that markets the FI directly or through a financial services entity.

31. The system of claim 30, wherein the second system further comprises:
an operations subsystem that tracks the FI, a purchaser of the FI, and use of the at least one perquisite provided for the FI;

32. The system of claim 31, wherein the second system further comprises:
a finance subsystem that collects revenues collected from a sale of the FI, a sale of the offered service and/or tangible product from the first perquisite.

33. The system of claim 32, wherein the second system further comprises:
an administration subsystem that handles the at least one feature of the FI.
